(19) United States
(12) Patent Application Publication
(10) Pub. No.: US 2014/0154563 A1
(43) Pub. Date: Jun. 5, 2014

(54) COMPOSITE PARTICLES FOR POSITIVE ELECTRODE OF ELECTROCHEMICAL ELEMENT, ELECTROCHEMICAL ELEMENT, AND METHOD FOR PRODUCING COMPOSITE PARTICLES FOR POSITIVE ELECTRODE OF ELECTROCHEMICAL ELEMENT

(71) Applicant: ZEON CORPORATION, TOKYO (JP)

(72) Inventor: Hiroki OGURO, Tokyo (JP)

(73) Assignee: ZEON CORPORATION, TOKYO (JP)

(21) Appl. No.: 14/096,146

(22) Filed: Dec. 4, 2013

(30) Foreign Application Priority Data
Dec. 5, 2012 (JP) 2012-266766
Nov. 7, 2013 (JP) 2013-231432

(51) Int. Cl. H01M 4/131

(52) U.S. Cl. CPC H01M 4/131
USPC 429/211; 429/223; 427/58; 252/506

(57) ABSTRACT

Composite particles for a positive electrode of an electrochemical element include a conductive material, a Ni containing positive electrode active material, a water soluble resin including a monomeric unit containing an acidic functional group, and a granular binder resin. The content of the water soluble resin is 1 to 10 parts by mass per 100 parts by mass of the Ni containing positive electrode active material. An electrochemical element includes a collector and a positive electrode active material layer obtained by formation with the composite particles. Furthermore, a method for producing the composite particles includes drying and granulating an aqueous slurry composition including the above components in order to obtain the composite particles. The content in the slurry composition of the water soluble resin is 1 to 10 parts by mass per 100 parts by mass of the Ni containing positive electrode active material.

### CROSS-REFERENCE TO RELATED APPLICATION

This application claims priority to and the benefit of Japanese Patent Application No. 2012-266766 filed Dec. 5, 2012 and Japanese Patent Application No. 2013-231432 filed Nov. 7, 2013, the entire contents of which are incorporated herein by reference.

### TECHNICAL FIELD

The present invention relates to composite particles for a positive electrode of an electrochemical element, an electrochemical element, and a method for producing composite particles for a positive electrode of an electrochemical element.

### BACKGROUND ART

Electrochemical elements such as a lithium ion secondary battery and an electric double layer capacitor have the characteristics of being small, lightweight, and high in energy density, and they can be repeatedly charged and discharged. These electrochemical elements are therefore widely used.

There is demand for increased capacity of such electrochemical elements. A variety of attempts have been made in recent years in order to further increase the capacity of electrochemical elements, such as the development of new electrode material. Specifically, in a positive electrode of an electrochemical element, the positive electrode having a positive electrode active material layer that includes a binder resin, positive electrode active material, conductive material, and the like formed on a collector, a technique has been proposed to increase the capacity of the electrochemical element by using a positive electrode active material that contains Ni (nickel) as the positive electrode active material (referred to below as “Ni containing positive electrode active material”).

During production of an electrochemical element electrode, the positive electrode active material layer is formed on the collector using a slurry composition in which electrode active material, conductive material, binder resin, and the like are dispersed in a solvent. In recent years, however, from the perspective of reducing the burden on the environment, interest in an aqueous slurry composition using an aqueous medium as the solvent has increased.

However, alkali content, such as lithium carbonate used during to production of the active material, remains in the above-described Ni containing positive electrode active material. Therefore, if the aqueous slurry composition including the Ni containing positive electrode active material is applied to a collector formed from aluminum or the like and dried in order to manufacture a positive electrode of an electrochemical element, the alkali content is eluted, causing the problem of the collector corroding. To address this problem, for example JP2011076981A (PTL 1) discloses a technique for producing a secondary battery positive electrode by first applying an aqueous slurry composition for a secondary battery positive electrode including Ni containing positive electrode active material onto a collector after setting the pH of the aqueous slurry composition to a specified range and then drying the aqueous slurry composition, so as to achieve a secondary battery that has excellent electrical characteristics while suppressing corrosion of the collector after application of the slurry composition.

### CITATION LIST

### Patent Literature

PTL 1: JP2011076981A

### SUMMARY OF INVENTION

### Technical Problem

Room for further improvement remains, however, in terms of further preventing corrosion of the collector in a secondary battery provided with a positive electrode obtained using the technique disclosed in PTL 1. Furthermore, the technique in PTL 1 has the problem of a cumbersome production process, since pH adjustment is necessary at the time of preparing the aqueous slurry composition.

Therefore, it is an object of the present invention to provide a positive electrode material for an electrochemical element, the positive electrode material being able to guarantee electrical characteristics when used for the positive electrode of an electrochemical element, being easy to produce, and being able to sufficiently suppress corrosion of the collector. It is also an object of the present invention to provide a method for producing the positive electrode material, and to provide an electrochemical element using the positive electrode material.

### Solution to Problem

The inventor engaged in intensive research to achieve the above objects. As a result, the inventor achieved the present invention by discovering that by using a slurry composition having blended therein a predetermined amount of a water soluble resin including a monomeric unit containing an acidic functional group and using the slurry composition as positive electrode material after transforming, the slurry composition into composite particles yields a positive electrode of an electrochemical element that can guarantee electrical characteristics when used in an electrochemical element. Furthermore, the positive electrode is easy to produce and can sufficiently suppress corrosion of the collector.

The main features of an aspect of the present invention for achieving the above objects are as follows.

Composite particles for a positive electrode of an electrochemical element include a conductive material, a Ni containing positive electrode active material, a water soluble resin including a monomeric unit containing an acidic functional group, and a granular binder resin, wherein a content of the water soluble resin including a monomeric unit containing an acidic functional group is 1 to 10 parts by mass per 100 parts by mass of the Ni containing positive electrode active material.

The composite particles for a positive electrode formed in this way by blending a predetermined amount of a water soluble resin including a monomeric unit containing an acidic functional group are easy to prepare, and using the composite particles for a positive electrode can also sufficiently suppress corrosion of the collector even when a Ni containing positive electrode active material is used. Furthermore, an electrochemical element obtained by using a positive electrode formed with these composite particles for a positive electrode has excellent electrical characteristics, such as capacity and output characteristics.

In the composite particles for a positive electrode according to the present invention, the Ni containing positive electrode active material is preferably coated with a coating material including a conductive material and a coating resin.

In this way, by using a Ni containing positive electrode active material coated with a coating material including a conductive material and a coating resin, elution of the alkali content from the Ni containing positive electrode active material can be suppressed, thereby further suppressing corrosion of the collector, while guaranteeing the electrical characteristics of an electrochemical element in which these composite particles are used in a positive electrode of the electrochemical element.

In the composite particles for a positive electrode according to the present invention, an SP value of the coating resin is preferably from 9.5 to 13 (cal/cm³)^{1/2}.

Thus using a Ni containing positive electrode active material coated with a coating material including a coating resin with an SP value from 9.5 to 13 (cal/cm³)^{1/2} allows for a sufficient guarantee of the electrical characteristics of the electrochemical element obtained by using the composite particles for an electrochemical element according to the present invention, in particular rate characteristics.

Furthermore, in the composite particles for a positive electrode according to the present invention, the Ni containing positive electrode active material is preferably a Li₂MnO₃—LiNiO₂ based solid solution positive electrode active material.

In this way, by using a Li₂MnO₃—LiNiO₂ based solid solution positive electrode active material as the Ni containing positive electrode active material, the electrochemical element obtained by using the composite particles for an electrochemical element according to the present invention can be provided with a sufficiently high capacity and sufficiently improved rate characteristics.

In the composite particles for a positive electrode according to the present invention, the water soluble resin including a monomeric unit containing an acidic functional group preferably includes at least one selected from the group consisting of a monomeric unit containing a sulfonic acid group, a monomeric unit containing a carboxyl group, and a monomeric unit containing a phosphoric acid group.

By thus using a water soluble resin that includes a monomeric unit containing at least one selected from the group consisting of a monomeric unit containing a sulfonic acid group, a monomeric unit containing a carboxyl group, and a monomeric unit containing a phosphoric acid group, corrosion of the collector when the composite particles for a positive electrode are used in a positive electrode can be further suppressed.

In the composite particles for a positive electrode according to the present invention, the granular binder resin preferably includes a monomeric unit of (meth)acrylic acid ester with a carbon number of 6 to 15, an α,β-unsaturated nitrile monomeric unit, and a monomeric unit containing a carboxylic acid group.

By the granular binder resin thus including a monomeric unit of (meth)acrylic acid ester with a carbon number of 6 to 15, an α,β-unsaturated nitrile monomeric unit, and a monomeric unit containing a carboxylic acid group, good ion conductivity is obtained and battery life can be extended when the composite particles for a positive electrode are used in a positive electrode. Additionally, the granular binder resin has excellent preservation stability, mechanical strength, and binding properties.

In the composite particles for a positive electrode according to the present invention, the granular binder resin preferably includes a monomeric unit of dibasic acid.

By the granular binder resin thus including a monomeric unit of dibasic acid, good ion conductivity is obtained and battery life can be extended when the composite particles for a positive electrode prepared using the slurry composition are used in a positive electrode. Additionally, the granular binder resin has excellent preservation stability, mechanical strength, and binding properties.

An electrochemical element includes a positive electrode including a collector and a positive electrode active material layer obtained by formation with the above composite particles for a positive electrode of an electrochemical element.

Such an electrochemical element can sufficiently suppress corrosion of the collector and has excellent electrical characteristics.

A method for producing composite particles for a positive electrode of an electrochemical element includes drying and granulating an aqueous slurry composition including a conductive material, a Ni containing positive electrode active material, a water soluble resin including a monomeric unit containing an acidic functional group, and a granular binder resin to obtain composite particles, wherein a content in the slurry composition of the water soluble resin including a monomeric unit containing an acidic functional group is 1 to 10 parts by mass per 100 parts by mass of the Ni containing positive electrode active material.

Composite particles for a positive electrode of an electrochemical element can easily be produced with such a method for production. By using the composite particles for a positive electrode produced with this method for production, corrosion of the collector can be sufficiently suppressed even when using a Ni containing positive electrode active material. Furthermore, an electrochemical element obtained by using a positive electrode formed with the composite particles for a positive electrode produced with this method for production has excellent electrical characteristics.

In the method for producing composite particles for a positive electrode according to the present invention, the water soluble resin including a monomeric unit containing an acidic functional group is preferably formed as an ammonium salt by at least one selected from the group consisting of ammonia and an amine compound with a molecular weight of at most 1000.

By thus forming the water soluble resin including a monomeric unit containing an acidic functional group as an ammonium salt, the solubility of the water soluble resin in an aqueous medium can be increased so as to more evenly disperse the water soluble resin in an aqueous slurry composition. Accordingly, corrosion of the collector can be suppressed even more effectively in the positive electrode obtained using the composite particles for a positive electrode of an electrochemical element produced with this method for production.

In the method for producing composite particles for a positive electrode according to the present invention, the Ni containing positive electrode active material is preferably coated with a coating material including a conductive material and a coating resin.

In this way, by using a Ni containing positive electrode active material coated with a coating material including a conductive material and a coating resin, elution of the alkali content from the Ni containing positive electrode active material can be suppressed, thereby further suppressing corrosion of the collector, while guaranteeing the electrical characteristics of an electrochemical element obtained by using the composite particles for a positive electrode of an electrochemical element produced with the method for production according to the present invention.

In the method for producing composite particles for a positive electrode according to the present invention, an SP value of the coating resin is preferably from 9.5 to 13 (cal/cm³)^{1/2}.

Thus using a Ni containing positive electrode active material coated with a coating material including a coating resin with an SP value from 9.5 to 13 (cal/cm³)^{1/2} allows for a sufficient guarantee of the electrical characteristics of the electrochemical element obtained by using the composite particles for an electrochemical element produced with the method for production according to the present invention, in particular rate characteristics.

In the method for producing composite particles for a positive electrode according to the present invention, the Ni containing positive electrode active material is preferably a Li₂MnO₃—LiNiO₂ based solid solution positive electrode active material.

In this way, by using a Li₂MnO₃—LiNiO₂ based solid solution positive electrode active material as the positive electrode active material, the electrochemical element obtained by using the composite particles for an electrochemical element produced with the method for production according to the present invention can be provided with a sufficiently high capacity and sufficiently improved rate characteristics.

### Advantageous Effect of Invention

According to the present invention, it is possible to provide composite particles, and a method for production thereof, that are appropriate as positive electrode material for an electrochemical element. Such positive electrode material guarantees electrical characteristics when used as the positive electrode in an electrochemical element, is easy to produce, and sufficiently suppresses corrosion of the collector.

Furthermore, according to the present invention, it is possible to provide an electrochemical element that can sufficiently suppress corrosion of the collector while having excellent electrical characteristics.

### DESCRIPTION OF EMBODIMENTS

### <Composite Particles for Positive Electrode>

The composite particles for a positive electrode according to the present invention are used when forming the positive electrode of an electrochemical element such as a lithium ion secondary battery or an electric double layer capacitor. The composite particles for a positive electrode according to the present invention include a conductive material, a Ni containing positive electrode active material, a water soluble resin including a monomeric unit containing an acidic functional group, and a granular binder resin. The content of the water soluble resin including a monomeric unit containing an acidic functional group is 1 to 10 parts by mass per 100 parts by mass of the Ni containing positive electrode active material.

Note that as described in detail below, the composite particles for a positive electrode according to the present invention are produced using a slurry composition that includes a conductive material, a Ni containing positive electrode active material, a water soluble resin including a monomeric unit containing an acidic functional group, and a granular binder resin.

The following describes each component of the composite particles for a positive electrode of an electrochemical element according to the present invention (referred to below as “composite particles” as appropriate).

### <<Conductive Material>>

The conductive material used in composite particles according to the present invention is not particularly limited. Examples include acetylene black, Ketjen black (registered trademark), carbon black, graphite, or other such conductive carbon material; and any of a variety of metallic fibers and foils. Acetylene black is particularly preferable. By including a conductive material, the composite particles can improve the electrical contact between portions of the Ni containing positive electrode active material and thereby improve the electrical characteristics (such as low temperature output characteristics), as well as other characteristics, of the electrochemical element using the positive electrode obtained by using the composite particles according to the present invention.

The conductive material is preferably granular, and the particle size is preferably at least 1 nm, more preferably at least 5 nm, preferably at most 500 nm, and more preferably at most 100 nm. By setting the particle size of the conductive material to at least 1 nm, the dispersiveness of the conductive material can be maintained in a good condition. By setting the particle size of the conductive material to at most 500 nm, the specific surface area can be set to a desired large value, thereby expressing the effects of the conductive material well (i.e. an improvement in the electrical contact between portions of the Ni containing positive electrode active material). As a result, the resistance can be set to a low value equal to or less than the desired value. Note that the 50% volume average particle size is used as the average particle size of the conductive material particles.

The content of the conductive material in the composite particles according to the present invention is not particularly limited, yet per 100 parts by mass of the below-described Ni containing positive electrode active material, the content is preferably at least 1 part by mass, more preferably at least 2 parts by mass, and even more preferably at least 3 parts by mass, and the content is preferably at most 10 parts by mass and more preferably at most 8 parts by mass. By setting the content of the conductive material to be within the above ranges, a high capacity can be made compatible with high rate characteristics in the electrochemical element using the positive electrode obtained by using the composite particles according to the present invention.

### <<Ni Containing Positive Electrode Active Material>>

In the composite particles according to the present invention, positive electrode active material including Ni is used as the positive electrode active material. The Ni containing positive electrode active material is not particularly limited, as long as it is an active material containing Ni as a transition metal. Examples include a lithium-nickel oxide (LiNiO₂), a lithium composite oxide of Co—Ni—Mn, a lithium composite oxide of Ni—Mn—Al, a lithium composite oxide of Ni—Co—Al, and a Li₂MnO₃—LiNiO₂ based solid solution. Among these, a Li₂MnO₃—LiNiO₂ based solid solution is preferable from the perspectives of increasing capacity and rate characteristics of the electrochemical element using the positive electrode obtained by using the composite particles according to the present invention.

A water soluble corrosive material, such as lithium carbonate, used during production of the active material remains in the above Ni containing positive electrode active material. When moisture is present around the Ni containing positive electrode active material, the corrosive material is eluted in the moisture. Therefore, the above Ni containing positive electrode active material is preferably coated with a coating material including a conductive material and a coating resin. By thus coating the Ni containing positive electrode active material with a coating material including a conductive material and a coating resin (the positive electrode active material coated with the coating material being referred below to as a “coated positive electrode active material” as appropriate), elution of the corrosive material, such as lithium carbonate, remaining in the Ni containing positive electrode active material can be prevented. Furthermore, as a result, when producing a positive electrode using the composite particles according to the present invention, corrosion of the collector due to the corrosive material in the composite particles can be suppressed. Including the conductive material in the coating material also allows for a guarantee of electrical characteristics of the positive electrode obtained by using the composite particles according to the present invention. Note that when using the coated positive electrode active material, a portion of the conductive material that is included in the composite particles is included in the coating material, yet the entire amount may be included in the coating material.

The following describes the properties of the coating resin, the conductive material included in the coating material, and the coated positive electrode active material, as well as a method of production thereof.

### —Coating Resin—

As the coating resin, a resin that does not dissolve in an aqueous medium and that can suppress elution of corrosive material from the Ni containing to positive electrode active material can be used. Specifically, the SP value (solubility parameter) is preferably at least 9.5 (cal/cm³)^{1/2}, more preferably at least 10 (cal/cm³)^{1/2}, preferably at most 13 (cal/cm³)^{1/2}, and more preferably at most 12 (cal/cm³)^{1/2}. When the SP value of the coating resin is at least 9.5 (cal/cm³)^{1/2}, the coating resin swells without dissolving upon contact with the electrolysis solution (organic electrolysis solution) normally used in an electrochemical element. Therefore, even if the positive electrode obtained by using composite particles that use the coated positive electrode active material is used in an electrochemical element, the coating resin swells sufficiently in the electrolysis solution, making it difficult for ion transfer to be blocked and keeping internal resistance to a low value, thus achieving good rate characteristics. By setting the SP value of the coating resin to be at most 13 (cal/cm³)^{1/2}, the coating resin does not dissolve in an aqueous medium, and when producing the composite particles, elution of corrosive material from the Ni containing positive electrode active material is suppressed. Therefore, corrosion of the collector can be sufficiently prevented.

The above SP value (solubility parameter) can be determined using the method described in “Polymer Handbook” VII Solubility Parameter Values, edited by E. H. Immergut, pp. 519-559 (John Wiley & Sons, 3^{rd} edition, 1989). For polymers not listed in this publication, the SP value can be determined with the molecular attraction constant method proposed by Small. This method determines the SP value (δ) with the following equation, based on characteristics of the functional group (atom group) forming a compound molecule, i.e. molecular attraction constant (G) statistics, the molecular weight (M), and the specific gravity (d).

δ=ΣG/V=dΣG/M (V: specific volume, M: molecular weight, d: specific gravity)

When two or more coating resins are used in combination to coat the surface of the particles in the Ni containing positive electrode active material, the SP value of the coating resin as a whole can be determined by calculation based on the SP value of each coating resin and the mixing molar ratio. Specifically, the SP value of each coating resin is weighted by the molar ratio to yield a weighted average, and the SP value of the coating resin as a whole is calculated.

If the coating resin dissolves in the electrolysis solution of the electrochemical element, the dissolved coating resin may cause the internal resistance of the electrochemical element to increase. Moreover, if the coating resin dissolves in the electrolysis solution of the electrochemical element, corrosion of the collector in the positive electrode of the electrochemical element may progress. Therefore, the swellability of the coating resin with respect to the electrolysis solution is such that the gel fraction measured using a Soxhlet extractor is preferably at least 30% by mass and more preferably at least 50% by mass. The gel fraction of the coating resin is normally assessed as the gel fraction calculated by extracting coating resin by refluxing 1.0 g of coating resin and 100 ml of electrolysis solution in a Soxhlet extractor for six hours and dividing the mass of the extracted coating resin by the mass of the original coating resin, e.g. 1.0 g (the residual gel fraction by electrolysis solution Soxhlet extraction).

As the solvent for the electrolysis solution of the secondary battery, a mixture of a high-permittivity solvent that has a high permittivity and easy electrolyte solvation (such as ethylene carbonate or propylene carbonate) and a low-viscosity solvent for decreasing the viscosity of the electrolysis solution and increasing the ion conductivity (such as 1,2-dimethoxyethane, diethyl carbonate, dimethyl carbonate, ethyl methyl carbonate, or the like) is generally used. The type and blending ratio of the solvent is selected so as to increase the conductivity of the electrolysis solution insofar as possible. For example, as a representative solvent for the electrolysis solution, a mixed solvent (EC/DEC) of ethylene carbonate (EC) and diethyl carbonate (DEC) or a mixed solvent (EC/EMC) of ethylene carbonate and ethyl methyl carbonate (EMC) is used.

The coating resin is preferably a resin that allows for dispersion of the coated positive electrode active material in an aqueous medium. The reason is that in the process of producing the composite particles, when granulating the composite particles using a slurry composition that includes the coated positive electrode active material, the coated positive electrode active material can be dispersed well in an aqueous medium in the slurry composition, thus achieving good handling of the slurry composition.

Furthermore, the coating resin preferably includes an acidic group. Due to the acidic group, the acid number of the coating resin is preferably greater than 0 mg KOH/g and is preferably at most 60 mg KOH/g, more preferably at most 50 mg KOH/g, and even more preferably at most 30 mg KOH/g. Furthermore, the base number of the coating resin is normally at most 5 mg HCl/g, preferably at most 1 mg HCl/g, and even more preferably zero. Increasing the acid number of the coating resin reliably prevents elution of corrosive material in the Ni containing positive electrode active material to an aqueous medium and prevents corrosion of the collector even more stably. Furthermore, setting the acid number to be at most 60 mg KOH/g increases the stability of the slurry composition. Examples of the acidic group include a carboxyl group, a hydroxyl group, a sulfonic acid group, a phosphoric acid group, a monoester phosphoric acid group, a polyoxyalkylene group, and the like.

A preferable example of the coating resin is an acrylic polymer that is dispersible in water. In the present disclosure, an “acrylic polymer” refers to a polymer that includes a monomeric unit of (meth)acrylic acid ester. Note that (meth)acrylic acid refers to acrylic acid and/or methacrylic acid, and (meth)acrylic acid ester refers to acrylic acid ester and/or methacrylic acid ester. Furthermore, in the present disclosure, “includes a monomeric unit” means “a structural unit derived from a monomer is included in the polymer obtained using the monomer”.

Examples of a (meth)acrylic acid ester monomer that can be used in production of the above acrylic polymer include methyl acrylate, ethyl acrylate, n-propyl acrylate, isopropyl acrylate, n-butyl acrylate, t-butyl acrylate, pentyl acrylate, hexyl acrylate, heptyl acrylate, octyl acrylate, 2-ethylhexyl acrylate, nonyl acrylate, decyl acrylate, lauryl acrylate, n-tetradecyl acrylate, stearyl acrylate, or other acrylic acid alkyl ester; methyl methacrylate, ethyl methacrylate, n-propyl methacrylate, isopropyl methacrylate, n-butyl methacrylate, t-butyl methacrylate, pentyl methacrylate, hexyl methacrylate, heptyl methacrylate, octyl methacrylate, 2-ethylhexyl methacrylate, nonyl methacrylate, decyl methacrylate, lauryl methacrylate, n-tetradecyl methacrylate, stearyl methacrylate, or other methacrylic acid alkyl ester; ethyleneglycol dimethacrylate, diethyleneglycol dimethacrylate, trimethylolpropane triacrylate, or other carboxylic acid ester which has two or more carbon-carbon double bonds; and the like. Among these, ethyl acrylate, butyl acrylate, and 2-ethylhexyl acrylate are preferable, with ethyl acrylate and butyl acrylate being more preferable. It is possible to use only one of the above alone, or to use two or more types in combination.

The content by percentage of the monomeric unit of (meth)acrylic acid ester in the acrylic polymer used as the coating resin is preferably at least 50% by mass and more preferably at least 60% by mass. Furthermore, the content is preferably at most 90% by mass and more preferably at most 80% by mass. Setting the content by percentage of the monomeric unit of (meth)acrylic acid ester to be at least 50% by mass makes the acrylic Polymer flexible, thereby preventing the occurrence of cracks upon use as a positive electrode for an electrochemical element. Furthermore, setting the content by percentage to be at most 90% by mass allows for good high temperature storage characteristics and low temperature output characteristics of the electrochemical element. Note that in the present disclosure, the “content by percentage of the monomeric unit” is expressed as the percentage occupied by a predetermined monomer among the entire sum of the mass of all monomers used in generation of the polymer.

In order to keep the acid number in the above-described ranges, the acrylic polymer used as the coating resin preferably includes a monomeric unit containing an acidic group. Examples of the monomer containing an acidic group included in the acrylic polymer used as the coating resin are a monomer containing a carboxylic acid group, a monomer containing a hydroxyl group, a monomer containing a sulfonic acid group, a monomer containing a phosphoric acid group, a monomer containing a monoester phosphoric acid group, a monomer containing a polyoxyalkylene group, and the like.

Examples of a monomer containing a carboxylic acid group that can be used in production of the above acrylic polymer include a monocarboxylic acid and its derivatives, as well as a dicarboxylic acid, its acid anhydrides, and their derivatives. Examples of a monocarboxylic acid include acrylic acid, methacrylic acid, and crotonic acid. Examples of a monocarboxylic acid derivative include 2-ethylacrylic acid, isocrotonic acid, α-acetoxyacrylic acid, β-trans-aryloxyacrylic acid, to α-chloro-β-E-methoxyacrylic acid, β-diaminoacrylic acid, and the like. Examples of a dicarboxylic acid include maleic acid, fumaric acid, itaconic acid, and the like. Examples of an acid anhydride of a dicarboxylic acid include maleic anhydride, acrylic anhydride, methylmaleic anhydride, dimethylmaleic anhydride, and the like. Examples of a dicarboxylic acid derivative include methylmaleic acid, dimethylmaleic acid, phenylmaleic acid, chloromaleic acid, dicyclomaleic acid, fluoromaleic acid, and the like. Further examples include maleic acid methylallyl, diphenyl maleate, nonyl maleate, decyl maleate, dodecyl maleate, octadecyl maleate, fluoroalkyl maleate, or other maleic acid ester.

Examples of the monomer containing a sulfonic acid group that can be used in production of the above acrylic polymer include vinyl sulfonic acid, methylvinyl sulfonic acid, (meth)acryl sulfonic acid, styrene sulfonic acid, 2-sulfonate-ethyl(meth)acrylate, 2-acrylamide-2-methylpropane sulfonic acid, 3-allyloxy-2-hydroxypropane sulfonic acid, and the like. Note that the (meth)acryl sulfonic acid refers to acryl sulfonic acid and/or methacryl sulfonic acid.

Examples of the monomer containing a phosphoric acid group or the monomer containing a monoester phosphoric acid group that can be used in production of the above acrylic polymer include 2-(meth)acryloyloxyethyl phosphate, methyl-2-(meth)acryloyloxyethyl phosphate, ethyl-(meth)acryloyloxyethyl phosphate, and the like. Note that (meth)acryloyl refers to acryloyl and/or methacryloyl.

Examples of the monomer containing a polyoxyalkylene group that can be used in production of the above acrylic polymer include a poly(alkyleneoxide), such as poly(ethyleneoxide), or the like.

Among these monomers containing an acidic group, a monomer containing a carboxylic acid group is preferable. Among these, a monocarboxylic acid with a carbon number of five or less having one carboxylic acid group, such as acrylic acid, methacrylic acid, or the like, is preferable, as is a dicarboxylic acid with a carbon number of five or less having two carboxylic acid groups, such as maleic acid, itaconic acid, or the like. Furthermore, among these examples, acrylic acid or methacrylic acid are preferable as they enhance the preservation stability of the acrylic polymer. It is possible to use only one type of the above monomers containing an acidic group, or to use two or more types in combination.

The content by percentage of the monomeric unit containing an acidic group in the acrylic polymer used as the coating resin is preferably at least 1% by mass and more preferably at least 1.5% by mass. Furthermore, the content is preferably at most 5% by mass and more preferably at most 4% by mass. Setting the content by percentage of the monomeric unit containing an acidic group to be at least 1% by mass keeps the acid number of the acrylic polymer within an appropriate range and allows for corrosion of the collector to be effectively suppressed, thereby enhancing the rate characteristics of the electrochemical element according to the present invention. Furthermore, the strength of the acrylic polymer is increased, as is the stability of the slurry composition. Setting the content by percentage of the monomeric unit containing an acidic group to be at most 5% by mass makes the acrylic polymer flexible, thereby providing good production stability and preservation stability of the slurry composition.

Furthermore, the acrylic polymer used as the coating resin preferably includes an α,β-unsaturated nitrile monomeric unit in order to improve the binding properties and the mechanical strength of the acrylic polymer. As an α,β-unsaturated nitrile monomer, acrylonitrile or methacrylonitrile, for example, are preferable from the viewpoint of improving the binding properties and mechanical strength, with acrylonitrile being particularly preferable. It is possible to use only one of the above alone, or to use two or more types in combination.

The content by percentage of the α,β-unsaturated nitrile monomeric unit in the acrylic polymer used as the coating resin is preferably at least 5% by mass and more preferably at least 10% by mass. Furthermore, the content is preferably at most 50% by mass and more preferably at most 40% by mass. Setting the content by percentage of the α,β-unsaturated nitrile monomeric unit to be at least 10% by mass allows for good mechanical strength of the acrylic polymer and for good adhesiveness between the coating resin and active material. Furthermore, setting the content by percentage to be at most 50% by mass allows for good flexibility of the acrylic polymer, thus preventing cracks in a positive electrode obtained using the composite particles that include the coated positive electrode active material.

The acrylic polymer used as the coating resin may include monomeric units other than those listed above. Examples of such other monomers include vinyl chloride, vinylidene chloride, or other halogen atom-containing monomer; vinyl acetate, vinyl propionate, vinyl butyrate, or other vinylesters; methylvinylether, ethylvinylether, butylvinylether, or other vinylethers; methylvinylketone, ethylvinylketone, butylvinylketone, hexylvinylketone, isopropenylvinylketone, or other vinylketones; N-vinylpyrrolidone, vinylpyridine, vinylimidazole, or other heterocyclic group-containing vinyl compound; and the like. It is possible to use only one of the above alone, or to use two or more types in combination.

The method for producing the acrylic polymer used suitably as the above coating resin is not particularly limited. Any of the following methods, for example, may be used: a solution polymerization method, suspension polymerization method, bulk polymerization method, emulsion polymerization method, or the like. As a polymerization method, an addition polymerization such as an ionic polymerization, radical polymerization, living radical polymerization, or the like may be used. As a polymerization initiator, any known polymerization initiator may be used, such as those disclosed in JP2012184201A, the entire contents of which are incorporated herein by reference.

The glass transition temperature of the coating resin is preferably at least −30° C., more preferably at least −10° C., and even more preferably at least 0° C. Furthermore, the glass transition temperature is preferably at most 100° C., more preferably at most 80° C., and even more preferably at most 70° C. Setting the glass transition temperature of the coating resin to be at least −30° C. lowers the blocking properties and increases dispersiveness of the coated positive electrode active material. Furthermore, setting the glass transition temperature to be at most 100° C. makes the acrylic polymer flexible, thus preventing the occurrence of cracks in a positive electrode obtained using the composite particles that include the coated positive electrode active material.

Per 100 parts by mass of the Ni containing positive electrode active material, the content of the coating resin in the coated positive electrode active material is preferably at least 0.1 parts by mass, more preferably at least 0.3 parts by mass, and even more preferably at least 0.5 parts by mass, and the content is preferably at most 10 parts by mass, more preferably at most 5 parts by mass, and even more preferably at most 4 parts by mass. Setting the amount of the coating resin to be at least 0.1 parts by mass per 100 parts by mass of the Ni containing positive electrode active material allows for a sufficient coverage factor, which is described below. Furthermore, setting the amount of the coating resin to be at most 10 parts by mass per 100 parts by mass of the Ni containing positive electrode active material decreases the amount of the coating resin that dissolves in the electrolysis solution, thereby suppressing an excessive rise in viscosity of the electrolysis solution and preventing an undesired suppression of the flow of lithium ions.

### —Conductive Material Included in the Coating Material—

The same material as the above-described conductive material may be used for the conductive material included in the coating material. The content of the conductive material in the coating material is not particularly limited, yet per 100 parts by mass of the Ni containing positive electrode active material, the content is preferably at least 0.5 parts by mass and more preferably at least 1 part by mass, and the content is preferably at most 10 parts by mass and more preferably at most 5 parts by mass. By setting the content of the conductive material in the coating material to be within the above ranges, a high capacity can be made compatible with high rate characteristics in the electrochemical element obtained by using the composite particles that include the coated positive electrode active material.

Note that as long as the effects of the present invention are not significantly impaired, the coating material may include components other than the coating resin and the conductive material.

### —Properties of the Coated Positive Electrode Active Material—

The thickness of the layer of coating material (coating material layer) in the coated positive electrode active material is preferably at least 0.2 μm, more preferably at least 0.3 μm, preferably at most 2 μm, and more preferably at most 1 μm. Setting the thickness of the coating material layer to be at least 0.2 μm allows for corrosion of the collector to be stably suppressed. Furthermore, setting the thickness to be at most 2 μm lowers the resistance of the coating material layer and increases the output characteristics of the electrochemical element obtained by using the composite particles that include the coated positive electrode active material.

The thickness of the coating material layer can be determined by dividing the mass of the coating material layer by the surface area of the particles in the positive electrode active material in order to calculate the mass of the coating material per unit of surface area, and then dividing the calculated mass of the coating material per unit of surface area by the density of the coating material. In this method of calculation, the thickness of the coating material layer is determined assuming that the coating material layer covers the entire surface of the particles in the positive electrode active material, yet the coating material layer does not necessarily cover the entire surface of the positive electrode active material. Accordingly, the value obtained in this method of calculation does not directly express the actual thickness of the coating material layer. Nevertheless, the value of the thickness of the coating material layer as determined by this method of calculation is a meaningful value for assessing the effects of forming the coating material layer.

The coating material does not necessarily need to cover the entire surface of the Ni containing positive electrode active material, yet coverage of a wide portion of the surface of the Ni containing positive electrode active material is preferable. Specifically, the coverage factor of the positive electrode active material by the coating material is preferably at least 50%, more preferably at least 70%, and even more preferably at least 80%. Note that the coverage factor can be measured with the method listed in the Examples section below.

### —Method for Producing Coated Positive Electrode Active Material—

Examples of a method for producing the coated positive electrode active material by coating the Ni containing positive electrode active material particles with the coating material include fluidized granulation, spray granulation, coagulant precipitation, pH precipitation, and the like. Among these, from the perspective of good drying efficiency, spray granulation is preferable. The following describes spray granulation.

Spray granulation is a method to obtain coated positive electrode active material by spray drying a slurry composition that includes a Ni containing positive electrode active material, a coating material, and an aqueous medium. A specific procedure is to prepare a slurry composition that includes a Ni containing positive electrode active material, a coating material, and an aqueous medium, and then to spray and dry this slurry composition so as to granulate a coated positive electrode active material.

Water is normally used as the aqueous medium. The amount of the aqueous medium that is used in the slurry composition is such that the solid content concentration in the slurry composition is preferably at least 1% by mass, more preferably at least 5% by mass, and even more preferably at least 10% by mass, and such that the solid content concentration is preferably at most 50% by mass, more preferably at most 40% by mass, and even more preferably at most 30% by mass. Keeping the amount of the aqueous medium within the above ranges allows for even dispersion of the coating material in the slurry composition.

Examples of the means for mixing the Ni containing positive electrode active material, the coating material, and the aqueous medium include mixers such as a ball mill, sand mill, bead mill, pigment disperser, grinder, ultrasonic disperser, homogenizer, planetary mixer, and the like. Mixing is normally performed at a temperature ranging from room temperature to 80° C. for 10 minutes to several hours. Note that as long as the effects of the present invention are not significantly impaired, the slurry composition may include components other than the Ni containing positive electrode active material, the coating material, and the aqueous medium.

The above slurry composition is sprayed using a spray drier so that drops of the sprayed slurry composition dry within a drying tower. This yields particles of coated positive electrode active material that contain the Ni containing positive electrode active material and coating material included in the drops. The temperature of the sprayed slurry composition is normally room temperature, yet the slurry composition may be heated to a higher temperature than room temperature. The temperature of the hot air during spray drying is normally from 80° C. to 250° C. and preferably from 100° C. to 200° C.

Furthermore, during the spray granulation, tumbling granulation of the resulting coated positive electrode active material may be performed, and heat treatment may be applied to the resulting coated positive electrode active material. Examples of the method for tumbling granulation include a rotary plate method, a rotary cylinder method, a rotary head cut cone method, and the like as disclosed in JP2008251965A, the entire contents of which are incorporated herein by reference. The temperature when tumbling the coated positive electrode active material is normally at least 80° C., preferably at least 100° C., normally at most 300° C., and preferably at most 200° C. from the perspective of removing the aqueous medium. The heat treatment is applied in order to harden the surface of the coated positive electrode active material, and the heat treatment temperature is normally from 80° C. to 300° C.

### <<Water Soluble Resin Including a Monomeric Unit Containing an Acidic Functional Group>>

The water soluble resin including a monomeric unit containing an acidic functional group (referred to below as “water soluble resin containing an acidic functional group” as appropriate) is a resin that allows for neutralization, via the acidic functional group, of the alkaline corrosive material that is eluted from the Ni containing positive electrode active material. The “water soluble resin containing an acidic functional group” is, for example, a resin that dissolves at a concentration of at least 10% by mass in an aqueous medium at pH 9 and preferably is a resin that dissolves at a concentration of at least 10% by mass in an aqueous medium at pH 5 to 9. In the composite particles according to the present invention, the water soluble resin containing an acidic functional group needs to be contained in the composite particles at a ratio of at least 1 part by mass and at most 10 parts by mass with respect to 100 parts by mass of the Ni containing positive electrode active material. The content of the water soluble resin containing an acidic functional group is preferably at most 5 parts by mass per 100 parts by mass of the Ni containing positive electrode active material. Setting the content of the water soluble resin containing an acidic functional group to these ranges allows for neutralization of the alkaline corrosive material that is eluted from the Ni containing positive electrode active material and for suppression of collector corrosion. Furthermore, setting the content as above allows for excellent electrical characteristics, such as rate characteristics and low temperature output characteristics, in an electrochemical element using the positive electrode obtained by using the composite particles according to the present invention.

The water soluble resin containing an acidic functional group can be prepared by addition polymerization of a monomer containing an acidic functional group and, as necessary, a monomeric composition including any other monomer. Examples of a monomer containing an acidic functional group that can be used in production of the water soluble resin containing an acidic functional group include a monomer containing a phosphoric acid group, a monomer containing a sulfonic acid group, and a monomer containing a carboxyl group. By thus using a water soluble resin that includes a monomeric unit containing at least one selected from the group consisting of a monomeric unit containing a phosphoric acid group, a monomeric unit containing a sulfonic acid group, and a monomeric unit containing a carboxyl group, corrosion of the collector can be sufficiently suppressed.

The monomer containing a phosphoric acid group that can be used in production of the water soluble resin containing an acidic functional group is a monomer containing a phosphoric acid group and a polymerizable group that can copolymerize with another monomer. Examples of the monomer containing a phosphoric acid group include a monomer containing a —O—P(═O)(—OR¹)—OR² group (R¹ and R² independently represent a hydrogen atom or any organic group) or a salt thereof. Examples of an organic group as R¹ and R² include an aliphatic group such as an octyl group, an aromatic group such as a phenyl group, and the like.

Examples of the monomer containing a phosphoric acid group that can be used in production of the water soluble resin containing an acidic functional group include a compound containing a phosphoric acid group and an allyloxy group; and a phosphoric acid group-containing (meth)acrylic acid ester. An example of a compound containing a phosphoric acid group and an allyloxy group is 3-allyloxy-2-hydroxypropane phosphate. Examples of a phosphoric acid group-containing (meth)acrylic acid ester include dioctyl-2-methacryloyloxyethyl phosphate, diphenyl-2-methacryloyloxyethyl phosphate, monomethyl-2-methacryloyloxyethyl phosphate, dimethyl-2-methacryloyloxyethyl phosphate, monoethyl-2-methacryloyloxyethyl phosphate, diethyl-2-methacryloyloxyethyl phosphate, monoisopropyl-2-methacryloyloxyethyl phosphate, diisopropyl-2-methacryloyloxyethyl phosphate, mono-n-butyl-2-methacryloyloxyethyl phosphate, di-n-butyl-2-methacryloyloxyethyl phosphate, monobutoxyethyl-2-methacryloyloxyethyl phosphate, dibutoxyethyl-2-methacryloyloxyethyl phosphate, mono(2-ethylhexyl)-2-methacryloyloxyethyl phosphate, di(2-ethylhexyl)-2-methacryloyloxyethyl phosphate, and the like.

The monomer containing a sulfonic acid group that can be used in production of the water soluble resin containing an acidic functional group is a monomer containing a sulfonic acid group and a polymerizable group that can copolymerize with another monomer. Examples of the monomer containing a sulfonic acid group include a monomer containing a sulfonic acid group with no functional group other than the sulfonic acid group and a polymerizable group, and salts thereof; a monomer containing an amide group in addition to a sulfonic acid group and a polymerizable group, and salts thereof; and a monomer containing a hydroxyl group in addition to a sulfonic acid group and a polymerizable group, and salts thereof.

Examples of a monomer containing a sulfonic acid group with no functional group other than the sulfonic acid group and a polymerizable group include vinyl sulfonic acid, styrene sulfonic acid, allyl sulfonic acid, sulfoethyl methacrylate, sulfopropyl methacrylate, sulfobutyl methacrylate, and the like. Examples of salts thereof include lithium salt, sodium salt, potassium salt, and the like. Examples of the monomer containing an amide group in addition to a sulfonic acid group and a polymerizable group include 2-acrylamide-2-methylpropane sulfonic acid (AMPS) and the like. Examples of salts thereof include lithium salt, sodium salt, potassium salt, and the like. Examples of the monomer containing a hydroxyl group in addition to a sulfonic acid group and a polymerizable group include 3-allyloxy-2-hydroxypropane sulfonic acid (HAPS) and the like. Examples of salts thereof include lithium salt, sodium salt, potassium salt, and the like. Among these, styrene sulfonic acid, 2-acrylamide-2-methylpropane sulfonic acid (AMPS), and salts thereof are preferable.

The monomer containing a carboxyl group that can be used in production of the water soluble resin containing an acidic functional group can be a monomer containing a carboxyl group and a polymerizable group. Examples of the monomer containing a carboxyl group include an ethylenically unsaturated carboxylic acid monomer.

Examples of the ethylenically unsaturated carboxylic acid monomer include an ethylenically unsaturated monocarboxylic acid and derivatives thereof, as well as an ethylenically unsaturated dicarboxylic acid, acid anhydrides thereof, and derivatives of the ethylenically unsaturated dicarboxylic acid and the acid anhydrides thereof. Examples of the ethylenically unsaturated monocarboxylic acid include acrylic acid, methacrylic acid, and crotonic acid. Examples of derivatives of the ethylenically unsaturated monocarboxylic acid include 2-ethylacrylic acid, isocrotonic acid, α-acetoxyacrylic acid, β-trans-aryloxyacrylic acid, α-chloro-β-E-methoxyacrylic acid, and β-diaminoacrylic acid. Examples of the ethylenically unsaturated dicarboxylic acid include maleic acid, fumaric acid, and itaconic acid. Examples of acid anhydrides of the ethylenically unsaturated dicarboxylic acid include maleic anhydride, acrylic anhydride, methylmaleic anhydride, and dimethylmaleic anhydride. Examples of derivatives of the ethylenically unsaturated dicarboxylic acid include methylmaleic acid, dimethylmaleic acid, phenylmaleic acid, chloromaleic acid, dichloromaleic acid, fluoromaleic acid, or other maleic acid methylallyl; and diphenyl maleate, nonyl maleate, decyl maleate, dodecyl maleate, octadecyl maleate, fluoroalkyl maleate, or other maleic acid ester. Among these, an ethylenically unsaturated monocarboxylic acid such as acrylic acid, methacrylic acid, and the like is preferable. The reason is that the dispersiveness in an aqueous solvent of the resulting water soluble resin containing an acidic functional group is further increased.

It is possible to use only one of the above monomers containing an acidic functional group alone, or to use two or more types in combination. Accordingly, the water soluble resin containing an acidic functional group used in an embodiment of the present invention may include only one type of monomeric unit containing an acidic functional group or may include two or more types in combination.

The content by percentage of the monomeric unit containing an acidic functional group in the water soluble resin containing an acidic functional group used in an embodiment of the present invention is preferably at least 5% by mass, more preferably at least 10% by mass, and even more preferably at least 20% by mass. Furthermore, the content is preferably at most 60% by mass, more preferably at most 50% by mass, and even more preferably at most 40% by mass. Setting the content by percentage of the monomeric unit containing an acidic functional group to be at least 5% by mass facilitates electrostatic repulsion from the Ni containing positive electrode active material, thus achieving good dispersiveness. On the other hand, setting the content by percentage of the monomeric unit containing an acidic functional group to be at most 60% by mass avoids excessive contact between the functional group and the electrolysis solution when a positive electrode is formed using the composite particles, thereby enhancing durability.

The water soluble resin containing an acidic functional group used in an embodiment of the present invention may include another monomeric unit in addition to the monomeric unit containing an acidic functional group. Examples of another monomeric unit include a fluorine-containing (meth)acrylic acid ester monomeric unit, a crosslinkable monomeric unit, a reactive surfactant monomeric unit, and a monomeric unit of (meth)acrylic acid ester not containing fluorine. Among these, inclusion of a fluorine-containing (meth)acrylic acid ester monomeric unit (i.e. that the water soluble resin containing an acidic functional group be a fluorine-based water soluble resin) is particularly preferable. Note that in the present disclosure, the term “monomeric unit of (meth)acrylic acid ester” used alone is taken to refer to a “monomeric unit of (meth)acrylic acid ester not containing fluorine”.

Examples of the fluorine-containing monomer of (meth)acrylic acid ester that can be used in production of the water soluble resin containing an acidic functional group include monomers represented by Formula (I) below.

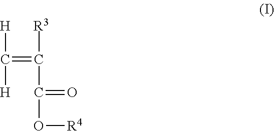

In Formula (I), R³ represents a hydrogen atom or a methyl group.

Furthermore, in Formula (I), R⁴ represents a hydrocarbon group containing a fluorine atom. The carbon number of the hydrocarbon group is normally at least 1 and at most 18. The number of fluorine atoms contained in R⁴ may be 1, or the number may be 2 or more.

Examples of the fluorine-containing (meth)acrylic acid ester monomer represented by Formula (I) include (meth)acrylic acid alkyl fluoride ester, (meth)acrylic acid aryl fluoride ester, and (meth)acrylic acid aralkyl, fluoride ester. Among these, (meth)acrylic acid alkyl fluoride ester is preferable. Examples of such monomers include (meth)acrylic acid perfluoroalkyl esters such as (meth)acrylic acid 2,2,2-trifluoroethyl ester, (meth)acrylic acid β-(perfluorooctyl)ethyl ester, (meth)acrylic acid 2,2,3,3-tetrafluoropropyl ester, (meth)acrylic acid 2,2,3,4,4,4-hexafluorobutyl ester, (meth)acrylic acid 1H,1H,9H-perfluoro-1-nonyl ester, (meth)acrylic acid 1H,1H,11H-perfluoroundecyl ester, (meth)acrylic acid perfluorooctyl ester, (meth)acrylic acid trifluoromethyl ester, and (meth)acrylic acid 3(4{1-trifluoromethyl-2,2-bis[bis(trifluoromethyl)fluoromethyl]ethynyloxy}benzooxy)-2-hydroxypropyl ester, and the like. It is possible to use only one of the above alone, or to use two or more types in combination.

The content by percentage of the fluorine-containing (meth)acrylic acid ester monomeric unit in the water soluble resin containing an acidic functional group used in an embodiment of the present invention is preferably at least 1% by mass, more preferably at least 2% by mass, and even more preferably at least 5% by mass. Furthermore, the content is preferably at most 20% by mass, more preferably at most 15% by mass, and even more preferably at most 10% by mass. Setting the content by percentage of the fluorine-containing (meth)acrylic acid ester monomeric unit to be at least 1% by mass provides the water soluble resin containing an acidic functional group with repulsion with respect to the electrolysis solution, thereby keeping the swellability in an appropriate range. On the other hand, setting the ratio of the fluorine-containing (meth)acrylic acid ester monomeric unit to be at most 20% by mass provides the water soluble resin containing an acidic functional group with wettability with respect to the electrolysis solution, thereby improving the low temperature output characteristics. Furthermore, appropriately adjusting the ratio of the fluorine-containing (meth)acrylic acid ester monomeric unit to be within the above ranges yields a water soluble resin containing an acidic functional group that has the desired glass transition temperature and molecular weight distribution.

As the crosslinkable monomer that can be used in production of the water soluble resin containing an acidic functional group, a monomer that can form a crosslinked structure when polymerized can be used. Examples of the crosslinkable monomer include a monomer having two or more reactive groups per molecule. In greater detail, examples include a monofunctional monomer having a thermal crosslinking group and one olefinic double bond per molecule, and a multifunctional monomer having two or more olefinic double bonds per molecule.

Examples of the thermal crosslinking group included in the monofunctional monomer include an epoxy group, N-methylol amide group, oxetanyl group, oxazoline group, and combinations thereof. Among these, an epoxy group is preferable for the ease with which its crosslink and crosslink density can be adjusted.

Examples of the crosslinkable monomer having an epoxy group as the thermal crosslinking group and having an olefinic double bond include vinyl glycidyl ether, allyl glycidyl ether, butenyl glycidyl ether, o-allyl phenyl glycidyl ether, or other unsaturated glycidyl ether; butadiene monoepoxide, chloroprene monoepoxide, 4,5-epoxy-2-pentene, 3,4-epoxy-1-vinyl cyclohexene, 1,2-epoxy-5,9-cyclododecadiene, or other monoepoxide of diene or polyene; 3,4-epoxy-1-butene, 1,2-epoxy-5-hexene, 1,2-epoxy-9-decene, or other alkenyl epoxide; as well as glycidyl acrylate, glycidyl methacrylate, glycidyl crotonate, glycidyl-4-heptenoate, glycidyl sorbate, glycidyl linoleate, glycidyl-4-methyl-3-pentenoate, glycidyl ester of 3-cyclohexenecarboxylic acid, glycidyl ester of 4-methyl-3-cyclohexenecarboxylic acid, or other glycidyl ester of unsaturated monocarboxylic acid.

Examples of the crosslinkable monomer having an N-methylol amide group as the thermal crosslinking group and having an olefinic double bond include (meth)acrylamides having a methylol group such as N-methylol(meth)acrylamide.

Examples of the crosslinkable monomer having an oxetanyl group as the thermal crosslinking group and having an olefinic double bond include 3-[(meth)acryloyloxymethyl]oxetane, 3-[(meth)acryloyloxymethyl]-2-trifluoromethyloxetane, 3-[(meth)acryloyloxymethyl]-2-phenyloxetane, 2-[(meth)acryloyloxymethyl]oxetane, and 2-[(meth)acryloyloxymethyl]-4-trifluoromethyloxetane.

Examples of the crosslinkable monomer having an oxazoline group as the thermal crosslinking group and having an olefinic double bond include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-methyl-2-oxazoline, and 2-isopropenyl-5-ethyl-2-oxazoline.

Examples of the multifunctional monomer having two or more olefinic double bonds include allyl(meth)acrylate, ethylene di(meth)acrylate, diethylene glycol di(meth)acrylate, triethylene glycol di(meth)acrylate, tetraethylene glycol di(meth)acrylate, trimethylolpropane-tri(meth)acrylate, dipropylene glycol diallyl ether, polyglycol diallyl ether, triethylene glycol divinylether, hydroquinone diallyl ether, tetraallyloxyethane, trimethylolpropane-diallyl ether, an allyl or vinyl ether of a multifunctional alcohol other than those listed above, triallylamine, methylene bisacrylamide, and divinyl benzene.

Among these, from the perspectives of suppressing an increase in viscosity of the slurry composition due to cross-linking at the time of drying, and of increasing strength of the positive electrode produced using the composite particles, ethylene dimethacrylate, allyl glycidyl ether, and glycidyl methacrylate are particularly preferable for use as the crosslinkable monomer.

The content by percentage of the crosslinkable monomeric unit in the water soluble resin containing an acidic functional group used in an embodiment of the present invention is preferably at least 0.1% by mass, more preferably at least 0.2% by mass, and even more preferably at least 0.5% by mass. Furthermore, the content is preferably at most 2% by mass, more preferably at most 1.5% by mass, and even more preferably at most 1% by mass. Setting the content by percentage of the crosslinkable monomeric unit to be within the above ranges suppresses the degree of swelling of the water soluble resin containing an acidic functional group and increases the durability of the positive electrode. Furthermore, appropriately adjusting the content by percentage of the crosslinkable monomeric unit to be within the above ranges yields a water soluble resin containing an acidic functional group that has the desired glass transition temperature and molecular weight distribution.

A reactive surfactant monomer that can be used in production of the water soluble resin containing an acidic functional group is a monomer containing a polymerizable group that can copolymerize with another monomer and containing a surfactant group (hydrophilic group and hydrophobic group). The reactive surfactant monomeric unit obtained by polymerization of a reactive surfactant monomer constitutes a portion of a water soluble polymer molecule and can achieve a surface activating effect. Therefore, stability at the time of production of the water soluble resin containing an acidic functional group improves.

Suitable examples of the reactive surfactant monomer include the compounds represented by Formula (II) below.

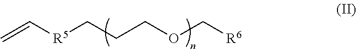

In Formula (II), R⁵ represents a divalent linking group. Examples of R⁵ include a —Si—O-group, methylene group, and phenylene group. Furthermore, in Formula (II), R⁶ represents a hydrophilic group. Examples of R⁶ include —SO₃NH₄. In Formula (II), n represents an integer from 1 to 100. It is possible to use only one type of reactive surfactant monomer or to use two or more types in combination at any ratio.

Other suitable examples of the reactive surfactant monomer include compounds containing a polymeric unit based on ethyleneoxide and a polymeric unit based on butyleneoxide and containing, at a terminal, an alkenyl group having a terminal double bond and —SO₃NH₄ (for example, products by the names of “LATEMUL PD-104” and “LATEMUL PD-105” manufactured by Kao Corporation).

The content by percentage of the reactive surfactant monomeric unit in the water soluble resin containing an acidic functional group used in an embodiment of the present invention is preferably at least 0.1% by mass, more preferably at least 0.2% by mass, and even more preferably at least 0.5% by mass. Furthermore, the content is preferably at most 5% by mass, more preferably at most 4% by mass, and even more preferably at most 2% by mass. Setting the ratio of the reactive surfactant monomeric unit to be at least 0.1% by mass allows for an increase in the dispersiveness of the water soluble resin containing an acidic functional group in the slurry composition upon production of the composite particles. On the other hand, setting the ratio of the reactive surfactant monomeric unit to be at most 5% by mass enhances the durability of the positive electrode.

Examples of the monomer of (meth)acrylic acid ester not containing fluorine that can be used in production of the water soluble resin containing an acidic functional group include methyl acrylate, ethyl acrylate, n-propyl acrylate, isopropyl acrylate, n-butyl acrylate, t-butyl acrylate, pentyl acrylate, hexyl acrylate, heptyl acrylate, octyl acrylate, 2-ethylhexyl acrylate, nonyl acrylate, decyl acrylate, lauryl acrylate, n-tetradecyl acrylate, stearyl acrylate, or other acrylic acid alkyl ester; and methyl methacrylate, ethyl methacrylate, n-propyl methacrylate, isopropyl methacrylate, n-butyl methacrylate, t-butyl methacrylate, pentyl methacrylate, hexyl methacrylate, heptyl methacrylate, octyl methacrylate, 2-ethylhexyl methacrylate, nonyl methacrylate, decyl methacrylate, lauryl methacrylate, n-tetradecyl methacrylate, stearyl methacrylate, or other methacrylic acid alkyl esters. It is possible to use only one of the above alone, or to use two or more types in combination.

The content by percentage of the monomeric unit of (meth)acrylic acid ester in the water soluble resin containing an acidic functional group used in an embodiment of the present invention is preferably at least 30% by mass, more preferably at least 35% by mass, and even more preferably at least 40% by mass. Furthermore, the content is preferably at most 90% by mass, more preferably at most 80% by mass, and even more preferably at most 70% by mass. Setting the content by percentage of the monomeric unit of (meth)acrylic acid ester to be at least 30% by mass increases adhesiveness of the composite particles to the collector, whereas setting the content by percentage to be at most 90% by mass suppresses a decrease in the water solubility of the water soluble resin containing an acidic functional group while maintaining a balance with the content by percentage of the other monomers.

Examples of monomeric units that can be included in the water soluble resin containing an acidic functional group used in an embodiment of the present invention other than those listed above include monomeric units derived from the following monomers. Specifically, the monomeric unit obtained by polymerizing one or more of the following may be used: styrene, chlorostyrene, vinyl toluene, t-butylstyrene, vinylbenzoic acid methyl ester, vinyl naphthalene, chloromethylstyrene, hydroxymethylstyrene, α-methylstyrene, divinyl benzene, or other styrene-based monomer; acrylamide or other amide-based monomer; acrylonitrile, methacrylonitrile, or other α,β-unsaturated nitrile compound monomer; ethylene, propylene, or other olefin-type monomer; vinyl chloride, vinylidene chloride, or other halogen atom-containing monomer; vinyl acetate, vinyl propionate, vinyl butyrate, vinyl benzoate, or other vinylester-type monomer; methylvinylether, ethylvinylether, butylvinylether, or other vinylether-type monomer; methylvinylketone, ethylvinylketone, butylvinylketone, hexylvinylketone, isopropenylvinylketone, or other vinylketone-type monomer; and to N-vinylpyrrolidone, vinylpyridine, vinylimidazole, or other heterocyclic group-containing vinyl compound monomer. The content by percentage of these units in the water soluble resin containing an acidic functional group is preferably from 0% by mass to 10% by mass, and more preferably from 0% by mass to 5% by mass.

The water soluble resin containing an acidic functional group used in an embodiment of the present invention can be produced with any method for production. For example, the water soluble resin containing an acidic functional group can be produced by addition polymerization, in an aqueous solvent, of a monomeric composition including a monomer containing an acidic functional group and, as necessary, a monomer providing any other unit. As the aqueous solvent used in the polymerization reaction, a known aqueous solvent may be used, for example as disclosed in JP2011204573A, the entire contents of which are incorporated herein by reference. Among these, water is preferable.

An addition polymerization reaction in such an aqueous solvent yields an aqueous solution in which water soluble resin containing an acidic functional group is dissolved in the aqueous solvent. The water soluble resin containing an acidic functional group may be extracted from the resulting aqueous solution, yet using the water soluble resin containing an acidic functional group in a dissolved state in the aqueous solvent, the below-described slurry composition containing the conductive material, the Ni containing positive electrode active material, the water soluble resin containing an acidic functional group, and the below granular binder resin can be prepared. The composite particles according to the present invention can then be produced using the slurry composition.

The glass transition temperature of the water soluble resin containing an acidic functional group used in an embodiment of the present invention is preferably at least 30° C., more preferably at least 35° C., and even more preferably at least 40° C. Furthermore, the glass transition temperature is preferably at most 80° C., more preferably at most 75° C., and even more preferably at most 70° C. Setting the glass transition temperature to be at least 30° C. enhances the durability of the positive electrode obtained by using the composite particles. Setting the glass transition temperature to be at most 80° C. enhances the adhesiveness of the composite particles to the collector.

The number average molecular weight of the water soluble resin containing an acidic functional group used in an embodiment of the present invention is preferably at least 1000, more preferably at least 1500, and even more preferably at least 2000. Furthermore, the number average molecular weight is preferably at most 100000, more preferably at most 80000, and even more preferably at most 60000. Setting the number average molecular weight to be within the above ranges heightens the water solubility of the water soluble resin containing an acidic functional group while also enhancing the durability of the positive electrode produced by using the composite particles.

Using GPC (Gel Permeation Chromatography), the number average molecular weight of the water soluble resin containing an acidic functional group can be calculated as the value in terms of polystyrene, using as the developing solvent a solution in which 0.85 g/ml of sodium nitrate are dissolved in a 10% by volume aqueous solution of dimethylformamide.

Note that the glass transition temperature and number average molecular weight of the water soluble resin containing an acidic functional group can be adjusted by combining a variety of monomers or by using a known molecular weight modifier.

### <<Granular Binder Resin>>

The composite particles according to the present invention include a granular binder resin.

The granular binder resin is a component that, in the positive electrode active material layer formed on the collector using the composite particles according to the present invention, can keep the components included in the positive electrode active material layer from separating from the positive electrode active material layer. In general, the granular binder resin in the positive electrode active material layer absorbs the electrolysis solution upon immersion in the electrolysis solution and swells while maintaining a granular shape, thereby promoting binding between portions of the positive electrode active material and preventing the positive electrode active material from falling off the collector. By including the granular binder resin in the composite particles according to the present invention, the positive electrode formed by using the composite particles can achieve a structure such that, in the electrolysis solution, the positive electrode has holes, yet the positive electrode active material is bound evenly by the granular binder resin. Accordingly, the electrochemical element using the positive electrode can maintain good capabilities.

In an embodiment of the present invention, a granular binder resin that can be dispersed in an aqueous medium is preferably used as the granular binder resin. It is possible to use only type of granular binder resin, or to use two or more types in combination.

Preferable examples of the granular binder resin include a diene polymer, acrylic polymer, fluoropolymer, silicon polymer, and the like. Among these, an acrylic polymer is preferable for its excellent oxidation resistance.

The acrylic polymer used as the granular binder resin is a polymer that includes a monomeric unit of (meth)acrylic acid ester. Among such polymers, a polymer that includes a monomeric unit of (meth)acrylic acid ester and includes at least one of a monomeric unit containing an acidic functional group and an α,β-unsaturated nitrile monomeric unit is preferable. A polymer that includes a monomeric unit of (meth)acrylic acid ester with a carbon number of 6 to 15, an α,β-unsaturated nitrile monomeric unit, and a monomeric unit containing a carboxylic acid group is more preferable.

Examples of the monomer of (meth)acrylic acid ester that can be used in production of the acrylic polymer include monomers similar to those listed in the section on the coating resin. Among these, monomers having a carbon number of at least 6, more preferably at least 7, and a carbon number of at most 15, more preferably at most 13, are preferable since such monomers can extend battery life and exhibit good ion conductivity due to appropriate swelling with respect to the electrolysis solution without being eluted in the electrolysis solution upon formation of a positive electrode using the composite particles. Among these, 2-ethylhexyl acrylate is particularly preferable. It is possible to use only one of the above alone, or to use two or more types in combination.

The content by percentage of the monomeric unit of (meth)acrylic to acid ester in the acrylic polymer used as the granular binder resin is preferably at least 50% by mass and more preferably at least 60% by mass. Furthermore, the content is preferably at most 95% by mass and more preferably at most 90% by mass. Setting the content by percentage of the monomeric unit derived from a monomer of (meth)acrylic acid ester to be at least 50% by mass increases the flexibility of the granular binder resin and makes it difficult for the positive electrode obtained by using the composite particles to crack. Furthermore, setting the content by percentage to be at most 95% by mass enhances the mechanical strength and binding properties of the granular binder resin.

Examples of the monomer containing an acidic functional group that can be used in production of the acrylic polymer include the monomers containing a carboxylic acid group, monomers containing a sulfonic acid group, and monomers containing a phosphoric acid group listed in the section on the coating resin. Among these, acrylic acid, methacrylic acid, methyl methacrylic acid ester, itaconic acid, 2-acrylamide-2-methylpropane sulfonic acid (AMPS), and phosphoric acid ethylene methacrylate are preferable. Furthermore, from the perspective of being able to increase preservation stability of the acrylic polymer, acrylic acid, methacrylic acid, and itaconic acid are more preferable, with itaconic acid being particularly preferable.

As the monomer containing an acidic functional group used in production of the acrylic polymer, use of dibasic acid monomer is preferable. In other words, the acrylic polymer preferably includes a monomeric unit of dibasic acid. Including a monomeric unit of dibasic acid provides the acrylic polymer with increased preservation stability. Furthermore, ion conductivity improves, and battery life is extended. Examples of the dibasic acid monomer include itaconic acid, mesaconic acid, citraconic acid, maleic acid, and fumaric acid. Among these, itaconic acid is preferable.

A monomeric unit of dibasic acid also provides a granular binder resin composed of a polymer other than an acrylic polymer with the above-described good ion conductivity and can increase battery life. Additionally, such a granular binder resin achieves the effects of excellent preservation stability, mechanical strength, and binding properties. In other words, the granular binder resin preferably includes a monomeric unit of dibasic acid.

It is possible to use only one of the above monomers containing an acidic functional group alone, or to use two or more types in combination.

The content by percentage of the monomeric unit containing an acidic functional group in the acrylic polymer used as the granular binder resin is preferably at least 1% by mass and more preferably at least 1.5% by mass. Furthermore, the content is preferably at most 5% by mass and more preferably at most 4% by mass. Setting the content by percentage of the monomeric unit containing an acidic functional group to be at least 1% by mass allows for an increase in the binding properties of the granular binder resin and improves the rate characteristics of the electrochemical element. Furthermore, setting the content by percentage to be at most 5% by mass allows for good production stability and preservation stability of the acrylic polymer.

As an α,β-unsaturated nitrile monomer, acrylonitrile or methacrylonitrile, for example, are preferable from the viewpoint of improving the mechanical strength and binding properties, with acrylonitrile being particularly preferable. It is possible to use only one of the above alone, or to use two or more types in combination.

The content by percentage of the α,β-unsaturated nitrile monomeric unit in the acrylic polymer used as the granular binder resin is preferably at least 3% by mass and more preferably at least 5% by mass. Furthermore, the content is preferably at most 40% by mass and more preferably at most 30% by mass. Setting the content by percentage of the α,β-unsaturated nitrile monomeric unit to be at least 3% by mass enhances the mechanical strength of the granular binder resin and improves adhesiveness between the coated positive electrode active material and the collector, as well as between portions of the coated positive electrode active material. Setting the content to be at most 40% by mass increases the flexibility of the granular binder resin and makes it difficult for the positive electrode obtained by using the composite particles to crack.

The acrylic polymer used as the granular binder resin may include a crosslinkable monomeric unit. Examples of the crosslinkable monomer include monomers similar to those listed in the section on the water soluble to resin containing an acidic functional group. It is possible to use only one of the above alone, or to use two or more types in combination.

The content by percentage of the crosslinkable monomeric unit in the acrylic polymer used as the granular binder resin is preferably at least 0.01% by mass and more preferably at least 0.05% by mass. Furthermore, the content is preferably at most 0.5% by mass and more preferably at most 0.3% by mass. Setting the content by percentage of the crosslinkable monomeric unit to be within the above ranges allows the acrylic polymer to exhibit appropriate swellability with respect to the electrolysis solution and further improves the rate characteristics and cycle characteristics of an electrochemical element using the positive electrode obtained by using the composite particles.

Furthermore, the acrylic polymer may include a monomeric unit derived from a monomer other than those described above. Examples of such a monomer include monomers similar to those listed in the section on the coating resin. It is possible to use only one of the above alone, or to use two or more types in combination.

The method for producing the granular binder resin is not particularly limited. Any of the following methods, for example, may be used: a solution polymerization method, suspension polymerization method, bulk polymerization method, emulsion polymerization method, or the like. As a polymerization method, an addition polymerization such as an ionic polymerization, radical polymerization, living radical polymerization, or the like may be used. As a polymerization initiator, any known polymerization initiator may be used, such as those disclosed in JP2012184201A, the entire contents of which are incorporated herein by reference.

The granular binder resin is normally produced in a dispersion liquid state, in which the granular binder resin is dispersed as particles within an aqueous medium. The granular binder resin is similarly included in a dispersed particle state in an aqueous medium in the slurry composition for producing the composite particles for a positive electrode of an electrochemical element. In the case of dispersion as particles within an aqueous medium, the 50% volume average particle size of the particles of the granular binder resin is preferably at least 50 nm, more preferably at least 60 nm, and even more preferably at least 70 nm. Furthermore, the 50% volume average particle size is preferably at most 200 nm, more preferably at most 185 nm, and even more preferably at most 160 nm. Setting the volume average particle size of the particles of the granular binder resin to be at least 50 nm improves the stability of the slurry composition. On the other hand, setting the volume average particle size to be at most 200 nm improves the binding properties of the granular binder resin.

The granular binder resin is normally stored and transported in the form of the above dispersion liquid. The solid content concentration of such a dispersion liquid is normally at least 15% by mass, preferably at least 20% by mass, and more preferably at least 30% by mass. Furthermore, the solid content concentration is normally at most 70% by mass, preferably at most 65% by mass, and more preferably at most 60% by mass. A solid content concentration of the dispersion liquid within the above ranges offers good workability when producing the slurry composition.

The pH of the dispersion liquid that includes the granular binder resin is preferably at least 5 and more preferably at least 7. Furthermore, the pH is preferably at most 13 and more preferably at most 11. Setting the pH of the dispersion liquid to be within the above ranges enhances stability of the granular binder resin.

The glass transition temperature of the granular binder resin is preferably at least −50° C., more preferably at least −45° C., and even more preferably at least −40° C. Furthermore, the glass transition temperature is preferably at most 25° C., more preferably at most 15° C., and even more preferably at most 5° C. Setting the glass transition temperature of the granular binder resin to be within the above ranges enhances strength and flexibility of the positive electrode produced using the composite particles and achieves superior low temperature output characteristics. Note that the glass transition temperature of the granular binder resin can be modified by, for example, changing the combination of monomers forming the monomeric units.

Per 100 parts by mass of the Ni containing positive electrode active material, the content of the granular binder resin in the composite particles according to the present invention is preferably at least 0.1 parts by mass and more preferably at least 0.5 parts by mass, and the content is preferably at most 5 parts by mass and more preferably at most 3 parts by mass. Setting the content of the granular binder resin to be at least 0.1 parts by mass per 100 parts by mass of the Ni containing positive electrode active material increases the binding properties between portions of the positive electrode active material, as well as between the composite particles and the collector, and also increases the rate characteristics. On the other hand, setting the content to be at most 5 parts by mass prevents the obstruction of ion transfer due to the granular binder resin when applying the positive electrode obtained by using the composite particles in an electrochemical element and reduces the internal resistance of the battery.

### <<Other Components>>

In addition to the above components, the composite particles for a positive electrode of an electrochemical element according to the present invention may, for example, include components such as a reinforcing material, dispersant, antioxidant, thickener, electrolysis solution additive having the function of suppressing electrolysis solution decomposition, and the like. Known components may be used for these other components, such as the components disclosed in JP2012204303A, the entire contents of which are incorporated herein by reference.

Among these other components, carboxymethyl cellulose is preferably used as a thickener to adjust the viscosity of the slurry composition used in production of the composite particles. Per 100 parts by mass of the Ni containing positive electrode active material, the content of the carboxymethyl cellulose in the composite particles according to the present invention is preferably at least 0.1 parts by mass and more preferably at least 0.5 parts by mass, and the content is preferably at most 3 parts by mass and more preferably at most 2 parts by mass. Setting the content of the carboxymethyl cellulose to be within the above ranges allows for sufficient stabilization of the viscosity of the slurry composition during the production process.

Note that while the carboxymethyl cellulose is a water soluble resin, it is a cellulose derivative formed by condensation polymerization of β-glucose, and therefore does not qualify as a water soluble resin including a monomeric unit containing an acidic functional group.

### —Properties of Composite Particles for Positive Electrode—

The average particle size of the composite particles for a positive electrode of an electrochemical element according to the present invention is preferably at least 30 μm and preferably at most 200 μm, more preferably being at most 100 μm. Setting the average particle size of the composite particles for a positive electrode to be at least 30 μm prevents decomposition of the electrolysis solution due to the specific surface area of the composite particles becoming too large, and setting the size to be at most 200 μm improves the filling fraction of the composite particles per unit volume when used for production of a positive electrode, thus yielding sufficient battery capacity. Note that the 50% volume average particle size is used as the average particle size of the composite particles.

The composite particles for a positive electrode according to the present invention have a structure such that in one particle, the Ni containing positive electrode active material and the conductive material are bound via the granular binder resin, and the water soluble resin including a monomeric unit containing an acidic functional group exists between or around the Ni containing positive electrode active material, the conductive material, and the granular binder resin. When the Ni containing positive electrode active material is coated by the coating material, portions of the coated positive electrode active material are bound to each other by the granular binder resin, or the coated positive electrode active material and the conductive material not included in the coating material layer of the coated positive electrode active material are bound by the granular binder resin. Additionally, the water soluble resin including the monomeric unit containing an acidic functional group exists between or around the coated positive electrode active material, the conductive material, and the granular binder resin.

Therefore, in the composite particles for a positive electrode, the conductive material can form a continuous structure, thereby forming a conductive path so as to lower resistance. Furthermore, even if alkaline corrosive material is eluted from the Ni containing positive electrode active material, protons (H⁺) derived from the acidic group in the water soluble resin including a monomeric unit containing an acidic functional group can neutralize the corrosive material. Moreover, when the coated positive electrode active material is used, the coating material layer suppresses elution of the corrosive material from the Ni containing positive electrode active material.

### <Method for Producing Composite Particles for Positive Electrode>

The following describes a method for producing the composite particles for a positive electrode of an electrochemical element according to the present invention. The method for producing the composite particles for a positive electrode according to the present invention includes drying and granulating a slurry composition including a conductive material, a Ni containing positive electrode active material, a water soluble resin including a monomeric unit containing an acidic functional group, and a granular binder resin. The water soluble resin including a monomeric unit containing an acidic functional group is included in the slurry composition at a ratio of 1 to 10 parts by mass per 100 parts by mass of the Ni containing positive electrode active material.

### <<Slurry Composition>>

In the method for production according to the present invention, the slurry composition includes a conductive material, a Ni containing positive electrode active material, a water soluble resin including a monomeric unit containing an acidic functional group, and a granular binder resin, like the above-described composite particles according to the present invention. Per 100 parts by mass of the Ni containing positive electrode active material, the content of the water soluble resin including a monomeric unit containing an acidic functional group is at least 1 part by mass and at most 10 parts by mass and is preferably at most 5 parts by mass. Setting the content of the water soluble resin containing an acidic functional group to be within the above ranges allows for suppression of corrosion of the collector in a positive electrode obtained by using the composite particles yielded by the method for production according to the present invention and achieves excellent rate characteristics and low temperature output characteristics in an electrochemical element using the positive electrode.

In the method for production according to the present invention, an aqueous medium is used as the medium to obtain the slurry composition. Normally, water is used. The amount of the aqueous medium that is used in the slurry composition is such that the solid content concentration in the slurry composition is preferably at least 1% by mass, more preferably at least 5% by mass, and even more preferably at least 10% by mass, and such that the solid content concentration is preferably at most 50% by mass, more preferably at most 40% by mass, and even more preferably at most 30% by mass. Keeping the amount of the aqueous medium within the above ranges allows for even dispersion of the components in the slurry composition.

In the method for production according to the present invention, the water soluble resin including a monomeric unit containing an acidic functional group is preferably formed as an ammonium salt by at least one selected from the group consisting of ammonia and an amine compound with a molecular weight of at most 1000 (referred to below as “low molecular weight compound X”). By thus forming a portion or the entirety of the acidic group in the water soluble resin including a monomeric unit containing an acidic functional group as an ammonium salt, the solubility of the water soluble resin with respect to water increases even if the slurry composition is prepared under alkaline conditions, thus allowing for even dispersion of the water soluble resin within the slurry composition.

Note that since these low molecular weight compounds X that bond with the acidic functional group desorb at the time of the below-described drying and granulating, the acidic functional group in the resulting composite particles returns to the conditions before formation of an ammonium salt.

The molecular weight of the amine compound is at most 1000, yet to facilitate vaporization at the time of drying and granulating, the molecular weight is preferably at most 200 and more preferably at most 150. The molecular weight of the amine compound is at least 31. The amine compound with a molecular weight of at most 1000 is not particularly limited. Examples include secondary amines such as dimethylamine, diethylamine, and dibutylamine; tertiary amines such as trimethylamine, triethylamine, tributylamine, and diazabicyclononene; and the like.

Among ammonia and the above amine compounds with a molecular weight of at most 1000, ammonia is particularly preferable as the low molecular weight compound X. The reason is that ammonia volatilizes easily at the time of drying and granulating, and unlike when using an amine salt or the like, no impurity such as a metal element remains in the composite particles at the time of volatilization.

In the slurry composition, per 100 parts by mass of the water soluble resin including a monomeric unit containing an acidic functional group, the content of the low molecular weight compound X is preferably at least 0.01 parts by mass, more preferably at least 0.05 parts by mass, and even more preferably at least 0.1 parts by mass, and the content is preferably at most 50 parts by mass, more preferably at most 40 parts by mass, and even more preferably at most 30 parts by mass. Setting the content of the low molecular weight compound X to be at least 0.01 parts by mass per 100 parts by mass of the water soluble resin including a monomeric unit containing an acidic functional group achieves sufficient solubility in water of the water soluble resin including a monomeric unit containing an acidic functional group, and setting the content to be at most 50 parts by mass allows for stable vaporization of the low molecular weight compound X at the time of drying and granulation.

In the method for production according to the present invention, the above slurry composition may include components other than those listed above, as long as the effects of the present invention are not significantly impaired.

The pH of the slurry composition is preferably at least 7, more preferably at least 8, and even more preferably at least 10. Furthermore, the pH is preferably at most 11. When the pH is within the above ranges, the dispersion stability of the slurry composition improves, thus remarkably achieving the effects of the present invention. Conversely, when the pH is less than 7, dispersion of the coated positive electrode active material becomes unstable, leading to the possible formation of agglomerates in the slurry composition.

The slurry composition can be obtained by mixing the above slurry composition components. Examples of the means for mixing include the mixers listed in the section on the method for producing the coated positive electrode active material. Mixing is normally performed at a temperature ranging from room temperature to 80° C. for 10 minutes to several hours.

### <<Step of Drying and Granulating>>

The above-described composite particles for a positive electrode according to the present invention can be obtained by drying and granulating the slurry composition prepared as above. The method for drying and granulating is not particularly limited. Examples include spray granulation, fluidized layer granulation, tumbling layer granulation, compression type granulation, stirring type granulation, extrusion granulation, grinder type granulation, fluidized layer multi-function type granulation, melting granulation, and the like. From the perspective of good drying efficiency, spray granulation is preferable among these methods.

The spray granulation can, for example, be performed like the spray granulation described in the section on the method for producing the coated positive electrode active material, using a slurry composition that includes a conductive material, a Ni containing positive electrode active material, a water soluble resin including a monomeric unit containing an acidic functional group, and a granular binder resin instead of a slurry composition that includes a Ni containing positive electrode active material, a coating material, and an aqueous medium.

### <Electrochemical Element>

An electrochemical element according to the present invention is not particularly limited and may be a lithium ion secondary battery or an electric double layer capacitor, preferably a lithium ion secondary battery. The electrochemical element according to the present invention includes a collector and a positive electrode active material layer obtained by formation with the composite particles for a positive electrode of an electrochemical element according to the present invention. In such an electrochemical element, the collector does not corrode easily, and the electrical characteristics such as rate characteristics and output characteristics are excellent.

The following describes the structure of a lithium ion secondary battery as an example of an electrochemical element according to the present invention. In addition to the above positive electrode, this lithium ion secondary battery is normally provided with a negative electrode, an electrolysis solution, and a separator. The following describes the structure of each of these components.

### <<Positive Electrode>>

As described above, the positive electrode of a lithium ion secondary battery according to the present invention includes a positive electrode active material layer and a collector.

### —Positive Electrode Active Material Layer—

The positive electrode active material layer constituting the positive electrode can be obtained by formation of the composite particles according to the present invention. Normally, the composite particles are formed by pressure forming. Pressure forming is a method for forming a positive electrode active material layer by applying pressure to the composite particles according to the present invention in order to rearrange and transform the composite particles, thereby increasing their density. Pressure forming can be performed with simple equipment.

Examples of pressure forming include a method to provide the composite particles according to the present invention to a pressure forming device via a feed device, such as a screw feeder, so as to form a positive electrode active material layer on a collector or on a substrate, a method to disperse the composite particles according to the present invention on a collector or a substrate and then form the composite particles with the pressure device, and a method to pack the composite particles according to the present invention in a mold and apply pressure to the mold for formation. Such pressure is, for example, applied with a mold press, a roller press, or the like. Using a roller press is particularly preferable in terms of production efficiency.

For the production of the positive electrode, a method to provide the composite particles according to the present invention to a roller pressure forming device via a feed device, such as a screw feeder, so as to form a positive electrode active material layer on a collector or on a substrate is preferable since such a method achieves excellent productivity. In this method, by sending the collector or the below-described substrate while simultaneously feeding the composite particles for a secondary battery positive electrode to the roll, the positive electrode active material layer can be layered directly on the collector or the substrate, thus yielding a collector or substrate with a positive electrode active material layer. The temperature of the roll during formation is preferably at least 25° C., more preferably at least 50° C., and even more preferably at least 70° C. Furthermore, the temperature is preferably at most 200° C., more preferably at most 150° C., and even more preferably at most 120° C. The press linear pressure of the roll during formation is preferably at least 10 kN/m, more preferably at least 200 kN/m, and even more preferably at least 300 kN/m. Furthermore, the pressure is preferably at most 1000 kN/m, more preferably at most 900 kN/m, and even more preferably at most 600 kN/m. Setting the temperature and the press line pressure of the roll during formation to be within the above ranges allows for even binding of the positive electrode active material layer on the collector or the substrate, thus achieving a positive electrode with excellent strength.

During production of the positive electrode, the positive electrode active material layer may be formed on the substrate, yet direct formation on the collector is preferable. Forming the positive electrode active material layer on the collector allows for formation of a more even positive electrode active material layer with high adhesiveness. As a result, the internal resistance of the battery lowers, thereby enhancing the charge-discharge cycle characteristics. Note that when the positive electrode active material layer is formed on the substrate, the positive electrode active material layer formed on the substrate is subsequently transferred onto the collector to form the positive electrode.

The substrate used in production of the positive electrode is used to support the positive electrode active material layer and to bind the positive electrode active material layer to the collector. The face of the substrate contacting the positive electrode active material layer may be roughened. As the material for the substrate, materials such as those disclosed in JP2010171366A, the entire contents of which are incorporated herein by reference, may for example be used.

In order to reduce variation in the thickness of the formed positive electrode active material layer and to increase capacity by raising the density of the positive electrode active material layer, production of the positive electrode preferably includes a further step to integrate the positive electrode active material layer and the collector by post-pressure. Hot pressing is typical as the method of post-pressure. Specific examples of hot pressing include a batch type hot press, a continuous hot roll press, and the like. For heightened productivity, a continuous hot roll press is preferable.

When the positive electrode active material layer is formed on a substrate, a complex composed of the collector, the positive electrode active material layer, and the substrate is preferably layered so that the positive electrode active material layer is sandwiched between the collector and the substrate. The positive electrode active material layer is then preferably bonded with hot pressing so as to become integrated with the collector, and preferably the substrate is subsequently peeled off. The method for peeling the substrate off of the positive electrode active material layer is not particularly limited. For example, after bonding the positive electrode active material layer to the collector, the substrate can easily be peeled off by winding the substrate and the collector to which the positive electrode active material layer is bonded around separate rolls. The positive electrode active material layer and the collector are integrated in this way.

Furthermore, a positive electrode active material layer may be formed on a collector, and a substrate on which a positive electrode active material layer is formed may be bonded by hot pressing to the other surface of the collector, with the substrate subsequently being peeled off in order to produce an electrode in which the positive electrode active material layer is formed on both surfaces of the collector.

The thickness of the positive electrode active material layer is not particularly limited but is normally at least 5 μm, preferably at least 10 μm, normally at most 150 μm, and preferably at most 100 μm. Setting the thickness of the positive electrode active material layer to be within the above ranges achieves both good rate characteristics and good energy density.

### —Collector—

A collector formed from aluminum or an aluminum alloy is used as a collector in the positive electrode. Aluminum and an aluminum alloy may be used in combination, or a combination of different types of aluminum alloys may be used. For the collector, a material having electrical conductivity and electrochemical durability is typically used. In particular, aluminum and aluminum alloys are heat resistant and electrochemically stable and are therefore excellent collector materials.

Examples of aluminum alloys include alloys of aluminum and one or more elements selected from the group consisting of iron, magnesium, zinc, manganese, and silicon.

The shape of the collector is not particularly limited, yet a sheet with a thickness of from 0.001 mm to 0.5 mm is preferable.

In order to increase the bonding strength of the positive electrode active material layer, roughening treatment may be applied in advance to the collector. Examples of the method for roughening include mechanical polishing, electropolishing, chemical polishing, and the like. During mechanical polishing, for example, a coated abrasive having abrasive particles bound thereto, a grinding stone, an emery wheel, a wire brush provided with steel wire, or the like is used.

### <<Negative Electrode>>

As the negative electrode of the secondary battery according to the present invention, any of a variety of negative electrodes normally used in an electrochemical element may be used. For example, when the electrochemical element is a lithium ion secondary battery, a metallic lithium laminate may be used. A collector having a negative electrode active material layer formed on the surface thereof may also be used.

The collector for the negative electrode is, for example, formed from a metal material such as iron, copper, aluminum, nickel, stainless steel, titanium, tantalum, gold, platinum, and the like. Among these, copper is particularly preferable for having high electrical conductivity and for being electrochemically stable.

The negative electrode active material layer is a layer including negative electrode active material and granular binder resin (binder).

Known materials may be used as the negative electrode active material and granular binder resin, such as those disclosed in JP2012204303A, the entire contents of which are incorporated herein by reference. A similar granular binder resin as that used in the positive electrode may be used. As necessary, components other than the negative electrode active material and granular binder resin may be included in the negative electrode active material layer.

The negative electrode is produced by, for example, preparing a negative electrode slurry composition including a negative electrode active material, binder resin, and aqueous medium, forming a layer of the negative electrode slurry composition on the collector, and drying the layer. The negative electrode may also be produced by drying and granulating the negative electrode slurry composition to yield composite particles and using the composite particles to form a negative electrode active material layer in the same way as the positive electrode active material layer of the above-described positive electrode.

### <<Electrolysis Solution>>

As the electrolysis solution of the secondary battery according to the present invention, an organic electrolysis solution in which a supporting electrolyte is dissolved in an organic solvent is normally used.

As the supporting electrolyte, a lithium salt is used when the electrochemical element is a lithium ion secondary battery. Lithium salts such as those disclosed in JP2012204303A, the entire contents of which are incorporated herein by reference, may for example be used as the lithium salt. Among these lithium salts, LiPF₆, LiClO₄, and CF₃SO₃Li are preferable, as they dissolve easily in an organic solvent and exhibit a high degree of dissociation. As a supporting electrolyte with an increasingly higher degree of dissociation is used, the lithium ion conductivity increases. Note that it is possible to use only one type of supporting electrolyte alone, or to use two or more types in combination.

An organic solvent that can dissolve the supporting electrolyte is used as the organic solvent. In the secondary battery according to the present invention, when the Ni containing positive electrode active material in the positive electrode active material layer is coated by the coating material, the organic solvent used in the electrolysis solution preferably has an appropriate SP value in order to allow the coating resin in the coating material to swell in the electrolysis solution. The specific SP value of the organic solvent is not uniform across types of coating resins, yet is preferably at least 7.0 (cal/cm³)^{1/2}, more preferably at least 7.5 (cal/cm³)^{1/2}, and even more preferably at least 8.0 (cal/cm³)^{1/2}. Furthermore, the SP value is preferably at most 16.0 (cal/cm³)^{1/2}, more preferably at most 15.0 (cal/cm³)^{1/2}, and even more preferably at most 12.0 (cal/cm³)^{1/2}.

Preferable organic solvents include, for example, those disclosed in JP2012204303A, the entire contents of which are incorporated herein by reference. Among these, dimethyl carbonate (DMC), ethylene carbonate (EC), diethyl carbonate (DEC), propylene carbonate (PC), butylene carbonate (BC), methylethyl carbonate (MEC), or other carbonates are preferable for their high relative dielectric constant and broad stable potential region. It is possible to use only one type of organic solvent alone, or to use two or more types in combination at any ratio.

The electrolysis solution may also contain an additive. Examples of the additive include carbonate-based compounds such as vinylene carbonate (VC).

Instead of the above-mentioned electrolysis solution, the following may be used as the electrolyte: polyethylene oxide, polyacrylonitrile, or other polymer electrolyte; a gel-state polymer electrolyte in which an electrolysis solution is impregnated in the above polymer electrolyte; LiI, Li₃N, or other inorganic solid electrolyte; or the like.

### <<Separator>>

Separators such as those disclosed in JP2012204303A, the entire contents of which are incorporated herein by reference, may for example be used as the separator. Among these, a microporous film which is formed from a polyolefin-based (polyethylene, polypropylene, polybutene, or polyvinyl chloride) resin is preferable since it allows for thinning of the separator as a whole, thereby raising the ratio of the electrode active material in the secondary battery and increasing the capacity per volume.

### <<Method for Producing Secondary Battery>>

The secondary battery according to the present invention may, for example, be produced by layering the above-described positive electrode on a negative electrode with the separator therebetween, inserting the resultant into a battery container by winding, bending, etc. as necessary in accordance with the battery shape, and sealing the battery container after injecting an electrolysis solution. To prevent a rise in pressure, an excessive discharge, or the like inside the secondary battery, a fuse, PTC device, or other overcurrent preventing device, or an expander metal, a lead plate, or the like may be provided as needed. The shape of the secondary battery may be a coin type, button type, sheet type, cylinder type, prism type, flat type, or the like.

### EXAMPLES

The following describes the present invention in detail based on examples, yet the present invention is not limited to these examples. In the following, “parts” and “%” are used to indicate amounts based on mass unless otherwise indicated. The following were used as the method for measuring the coverage factor of the coating material, the method for assessing corrosiveness of the collector, the method for assessing rate characteristics of the secondary battery, and the method for assessing the low temperature output characteristics of the secondary battery.

### <Method of Measuring Coverage Factor by Coating Material>

The coated positive electrode active material was dispersed in an epoxy resin, and the epoxy resin was hardened. Subsequently, the epoxy resin was cooled at a temperature of −80° C. and cut in a microtome to produce a thin slice. Vapor of a ruthenium tetroxide aqueous solution with a 0.5% concentration by mass was blown at the thin slice for approximately 5 minutes to stain the coated polymer layer, and the cut surface was observed with a Transmission Electron Microscope (TEM). Observation was performed at 2000× to 6000×, adjusting so that 5 to 20 coated positive electrode active material cross-sections were observable in a 28 μM by 35 μm range. From among these, 100 were selected, and the conditions of coverage were observed. During observation, the resulting image was visually observed to classify coated positive electrode active material in which at least 80% of the cross-sectional length was coated as rank A and coated positive electrode active material in which 50% to 79% was coated as rank B. The coverage factor (%) was then calculated as (number classified as rank A)+0.5×(number classified as rank B).

### <Method for Assessing Corrosiveness of the Collector>

The positive electrode active material layer including the positive electrode active material was peeled off of the secondary battery positive electrode by ultrasound in water, and the peeled face of the collector was analyzed by X-ray Photoelectron Spectroscopy (XPS). Peak separation was performed on the resulting spectrum of the oxygen 1 s orbital, and the peak due to aluminum oxide was separated from the peak due to aluminum hydroxide. From the intensity ratio, the (peak area due to aluminum hydroxide)×100/(peak area due to oxygen 1 s orbital) was calculated. This value was used as the assessment standard for the corrosiveness of the collector, which was assessed on the following scale. A higher value represents greater corrosion and occurrence of aluminum hydroxide.

A: less than 40%

B: at least 40% and less than 50%

C: at least 50% and less than 60%

D: at least 60% and less than 70%

E: at least 70%

### <Method for Assessing Rate Characteristics>

Using the laminated cells produced as Examples and Comparative Examples, a charge-discharge cycle at 25° C. to charge to 4.2 V at a constant current of 0.1 C and then to discharge to 3.0 Vat a constant current of 0.1 C, and a charge-discharge cycle at 25° C. to charge to 4.2 V at a constant current of 0.1 C and then to discharge to 3.0 V at a constant current of 2.0 C were performed. The ratio of the discharge capacity at 2.0 C to the battery capacity at 0.1 C was calculated as a percentage and used to assess the charge-discharge rate characteristics.

Note that the battery capacity at 0.1 C refers to the discharge capacity at the time of discharge to 3.0 V at a constant current of 0.1 C, whereas the discharge capacity at 2.0 C refers to the discharge capacity at the time of discharge to 3.0 V at a constant current of 2.0 C.

The charge-discharge rate characteristics were assessed on the following scale. A larger value for the charge-discharge rate characteristics (referred to in the present disclosure as “rate characteristics”) indicates smaller internal resistance and the capability of high-speed charge and discharge.

A: charge-discharge rate characteristics of at least 80%

B: charge-discharge rate characteristics of at least 75% and less than 80%

C: charge-discharge rate characteristics of at least 70% and less than 75%

D: charge-discharge rate characteristics of less than 70%

### <Method for Assessing Low Temperature Output Characteristics>

The laminated cells produced as Examples and Comparative Examples were charged at 25° C. to a State Of Charge (SOC) of 50% at a constant current of 0.1 C, and a voltage V0 was measured. Subsequently, the cells were discharged at −10° C. for 10 seconds at a constant current of 1.0 C, and a voltage V1 was measured. Based on these measurements results, a voltage drop ΔV=V0−V1 was calculated.

The calculated voltage drop ΔV was assessed on the following scale. A smaller value for the voltage drop ΔV indicates better low temperature output characteristics.

A: voltage drop ΔV of at least 100 mV and less than 120 mV

B: voltage drop ΔV of at least 120 mV and less than 140 mV

C: voltage drop ΔV of at least 140 mV and less than 160 mV

D: voltage drop ΔV of at least 160 mV

Water soluble resins 1 to 3 including a monomeric unit containing an acidic functional group, coating resins 1 to 3, and granular binder resins 1 and 2 were produced as follows.

### <Production of Water Soluble Resin 1 Including a Monomeric Unit Containing an Acidic Functional Group>

Into a 1 L SUS separable flask provided with an agitator, a reflux cooling tube, and a thermometer, 32.5 parts of methacrylic acid as a monomer containing an acidic functional group, 0.8 parts of ethylene dimethacrylate as a crosslinkable monomer, 7.5 parts of 2,2,2-trifluoroethyl methacrylate as a fluorine-containing (meth)acrylic acid ester monomeric unit, 58.0 parts of butyl acrylate as a monomeric unit of (meth)acrylic acid ester, 1.2 parts of polyoxyalkylene alkenyl ether ammonium sulfate (“LATEMUL PD-104” manufactured by Kao Corporation) in terms of solid content as a reactive surfactant monomer, 0.6 parts of t-dodecyl mercaptan, 150 parts of deionized water, and 0.5 parts of potassium persulfate as a polymerization initiator were added. The mixture was agitated thoroughly and then heated to 60° C. to begin polymerization. When the polymer conversion rate reached 96%, the mixture was cooled to stop the reaction, yielding a mixture including the water soluble resin 1 containing an acidic functional group.

10% ammonia water was added to the mixture including the water soluble resin 1 containing an acidic functional group (the amount of ammonia being 1.5 parts per 100 parts of the water soluble resin 1 containing an acidic functional group) to adjust to pH 8, yielding an aqueous solution including the water soluble resin 1 containing an acidic functional group.

### <Production of Water Soluble Resin 2 Including a Monomeric Unit Containing an Acidic Functional Group>

Into a 1 L SUS separable flask provided with an agitator, a reflux cooling tube, and a thermometer, 20 parts of diphenyl-2-methacryloyloxyethyl phosphate as a monomer containing an acidic functional group, 2.5 parts of 2,2,2-trifluoromethyl methacrylate as a fluorine-containing (meth)acrylic acid ester monomeric unit, 77.5 parts of butyl acrylate as a monomeric unit of (meth)acrylic acid ester, 1.0 part of sodium dodecylbenzenesulfonate as an emulsifier, 150 parts of deionized water, and 0.5 parts of potassium persulfate as a polymerization initiator were added. The mixture was agitated thoroughly and then heated to 60° C. to begin polymerization. When the polymer conversion rate reached 96%, the mixture was cooled to stop the reaction, to yielding a mixture including the water soluble resin 2 containing an acidic functional group.

10% ammonia water was added to the mixture including the water soluble resin 2 containing an acidic functional group (the amount of ammonia being 1.5 parts per 100 parts of the water soluble resin 2 containing an acidic functional group) to adjust to pH 8, yielding an aqueous solution including the water soluble resin 2 containing an acidic functional group.

### <Production of Water Soluble Resin 3 Including a Monomeric Unit Containing an Acidic Functional Group>

Into a 1 L SUS separable flask provided with an agitator, a reflux cooling tube, and a thermometer, desalinated water was injected in advance, thoroughly agitated, and subsequently heated to 70° C. Then, 0.2 parts of potassium persulfate aqueous solution were added.

Into a separate 5 MPa pressure tight container with an agitator, a mixture including 30 parts of methacrylic acid and 2.5 parts of 2-acrylamide-2-methylpropane sulfonic acid (AMPS) as a monomer containing an acidic functional group, 35 parts of ethyl acrylate and 32.5 parts of butyl acrylate as monomers of (meth)acrylic acid ester, 0.115 parts in terms of solid content of a 30% concentration of sodium dodecyldiphenylethersulfonate as an emulsifier, 50 parts of deionized water, and 0.4 parts of sodium hydrogen carbonate was injected and thoroughly stirred to produce an aqueous emulsion.

The resulting aqueous emulsion was continuously dripped into the above separable flask for 4 hours. When the polymer conversion rate reached 90%, the reaction temperature was set to 80° C., and after reacting for 2 more hours, the mixture was cooled to stop the reaction when the polymer conversion rate reached 99%, yielding a mixture including the water soluble resin 3 containing an acidic functional group.

10% ammonia water was added to the mixture including the water soluble resin 3 containing an acidic functional group (the amount of ammonia being 1.5 parts per 100 parts of the water soluble resin 3 containing an acidic functional group) to adjust to pH 8, yielding an aqueous solution including the water soluble resin 3 containing an acidic functional group.

### <Production of Granular Binder Resin 1>

Into a 1 L SUS separable flask provided with an agitator, a reflux cooling tube, and a thermometer, 130 parts of deionized water were added, and then 0.8 parts of ammonium persulfate as a polymerization initiator and 10 parts of deionized water were further added. The resultant was heated to 80° C.

In a separate container with an agitator, 76 parts of 2-ethylhexyl acrylate as a monomer of (meth)acrylic acid ester, 20 parts of acrylonitrile as an α,β-unsaturated nitrile monomer, 4.0 parts of itaconic acid as a monomer containing an acidic functional group, 2.0 parts of sodium dodecylbenzenesulfonate as an emulsifier, and 377 parts of deionized water were added and thoroughly stirred to prepare an emulsion.

The resulting emulsion was continuously added to the separable flask for 3 hours. After 2 hours of further reaction, the resultant was cooled to stop the reaction. 10% ammonia water was then added to adjust to pH 7.5, yielding an aqueous dispersion of the granular binder resin 1. The polymer conversion rate was 98%. Note that in the granular binder resin 1, the content by percentage of the monomer of (meth)acrylic acid ester was 76% by mass, the content by percentage of the α,β-unsaturated nitrile monomer was 20% by mass, and the content by percentage of the monomer containing an acidic group was 4.0% by mass. The glass transition temperature of the resulting granular binder resin 1 was −30° C., and the volume average Particle size was 150 nm.

### <Production of Granular Binder Resin 2>

An aqueous dispersion of the granular binder resin 2 was obtained similarly to the granular binder resin 1, differing in that 78 parts of 2-ethylhexyl acrylate were used, and 2.0 parts of methacrylic acid were used instead of 4.0 parts of itaconic acid. The polymer conversion rate was 98%. Note that in the granular binder resin 2, the content by percentage of the monomer of (meth)acrylic acid ester was 78% by mass, the content by percentage of the α,β-unsaturated nitrile monomer was 20% by mass, and the content by percentage of the monomer containing an acidic group was 2.0% by mass. The glass transition temperature of the resulting granular binder resin 2 was −40° C., and the volume average particle size was 200 nm.

### <Production of Coating Resin 1>

Into a 1 L SUS separable flask provided with an agitator, a reflux cooling tube, and a thermometer, 250 parts of deionized water and 2 parts of sodium dodecyldiphenylethersulfonate as an emulsifier were added, and after thorough stirring, the resultant was heated to 70° C., and 0.2 parts in terms of solid content of a potassium persulfate aqueous solution were added.

In a separate container with an agitator, 50 parts of deionized water, 0.4 parts of sodium hydrogen carbonate, 0.12 parts in terms of solid content of a 30% concentration of sodium dodecyldiphenylethersulfonate as an emulsifier, 3.0 parts of methacrylic acid as a monomer containing an acidic group, 47 parts of ethyl acrylate and 20 parts of butyl acrylate as monomers of (meth)acrylic acid ester, and 30 parts of acrylonitrile as an α,β-unsaturated nitrile monomer were added and thoroughly stirred to prepare an emulsion.

The resulting emulsion was continuously added to the separable flask for 4 hours, subsequently heated to 80° C., and further reacted for 2 hours. The resulting mixture was cooled to stop the reaction, yielding an aqueous dispersion of the coating resin 1. The polymer conversion rate was 99%. Note that in the coating resin 1, the content by percentage of the monomer of (meth)acrylic acid ester was 67% by mass, the content by percentage of the α,β-unsaturated nitrile monomer was 30% by mass, and the content by percentage of the monomer containing an acidic group was 3.0% by mass. Furthermore, the glass transition temperature of the coating resin 1 was 7° C., and the SP value was 11.45 (cal/cm³)^{1/2}.

### <Production of Coating Resin 2>

An aqueous dispersion of the coating resin 2 was obtained in the same way as the coating resin 1 was produced, differing in that 32 parts of ethyl acrylate, 54 parts of butyl acrylate, 4 parts of methacrylic acid, and 10 parts of acrylonitrile were used. The polymer conversion rate was 99%. Note that in the coating resin 2, the content by percentage of the monomer of (meth)acrylic acid ester was 86% by mass, the content by percentage of the α,β-unsaturated nitrile monomer was 10% by mass, and the content by percentage of the monomer containing an acidic group was 4.0% by mass. Furthermore, the glass transition temperature of the coating resin 2 was −26° C., and the SP value was 10.57 (cal/cm³)^{1/2}.

### <Production of Coating Resin 3>

An aqueous dispersion of the coating resin 3 was obtained in the same way as the coating resin 1 was produced, differing in that 46 parts of ethyl acrylate, 10 parts of butyl acrylate, 4 parts of methacrylic acid, and 40 parts of acrylonitrile were used. The polymer conversion rate was 99%. Note that in the coating resin 3, the content by percentage of the monomer of (meth)acrylic acid ester was 56% by mass, the content by percentage of the α,β-unsaturated nitrile monomer was 40% by mass, and the content by percentage of the monomer containing an acidic group was 4.0% by mass. Furthermore, the glass transition temperature of the coating resin 3 was 27° C., and the SP value was 11.91 (cal/cm³)^{1/2}.

### Example 1

The composite particles and secondary battery of Example 1 were produced with the following steps.

### (a) Production of Coated Positive Electrode Active Material

The concentration of the aqueous dispersion of the coating resin 1 obtained as above was adjusted to yield a 28% aqueous dispersion.

100 parts of a Li₂MnO₃—LiNiO₂ based solid solution positive electrode active material, 2 parts in terms of solid content of the 28% aqueous dispersion of the coating resin 1, and 2 parts of acetylene black (“HS-100” manufactured by Denki Kagaku Kogyo Kabushiki Kaisha) were added to a homomixer. The overall solid content concentration was adjusted to 20% with deionized water, and the resultant was agitated to obtain a slurry composition.

The slurry composition was fed to a spray dryer (“OC-16” manufactured by Ohkawara Kakohki Co., Ltd.) and spray dried using a rotating disk atomizer (65 mm diameter) under the following conditions to yield the coated positive electrode active material 1: rotation speed of 25000 rpm, hot air temperature of 150° C., and particle recovery outlet temperature of 90° C. The volume average particle size was 8.5 μm, and the coverage factor was 84%.

### (b) Production of Composite Particles

The concentration of the aqueous dispersion of the granular binder resin 1 obtained as above was adjusted to yield a 40% aqueous dispersion.

104 parts of the coated positive electrode active material 1, 3 parts of acetylene black (“HS-100” manufactured by Denki Kagaku Kogyo Kabushiki Kaisha), 2 parts in terms of solid content of an aqueous solution including the water soluble resin 1 containing an acidic functional group, 1 part in terms of solid content of a 1% aqueous solution of carboxymethyl cellulose (“BSH-6” manufactured by Dai-Ichi Kogyo Seiyaku Co., Ltd.), and 2 parts in terms of solid content of a 40% aqueous dispersion of the granular binder resin 1 were added to a planetary mixer. The overall solid content concentration was adjusted to 20% with deionized water, and the resultant was agitated to obtain a slurry composition for composite particles.

The slurry composition for composite particles was fed to a spray dryer (“OC-16” manufactured by Ohkawara Kakohki Co., Ltd.) and spray dried using a rotating disk atomizer (65 mm diameter) under the following conditions to yield composite particles 1: rotation speed of 25000 rpm, hot air temperature of 150° C., and particle recovery outlet temperature of 90° C. The volume average particle size was 65 μm.

### (c) Production of Positive Electrode

The composite particles 1 obtained as above were fed to pressure rollers (roll temperature: 100° C., press line pressure: 500 kN/m) of a roll presser (“Pushing cut rough-surface heat roll” manufactured by Hirano Gikenkogyo Co., Ltd.) using a volumetric feeder (“Nikka K-V spray” manufactured by Nikka Ltd.). A 20 μm thick aluminum foil was inserted between the pressure rollers, and the composite particles 1 for a secondary battery positive electrode fed from the volumetric feeder were adhered to the aluminum foil (collector). Pressure formation at a formation rate of 1.5 m/min yielded a positive electrode having positive electrode active material (in Table 1, this positive electrode production method is listed as “α”).

### (d) Production of Negative Electrode Slurry Composition

100 parts of artificial graphite with a specific surface area of 4 m²/g as negative electrode active material (average particle size: 24.5 μm) and 1 part in terms of solid content of a 1% aqueous solution of carboxymethyl cellulose (“BSH-12” manufactured by Dai-Ichi Kogyo Seiyaku Co., Ltd.) as a dispersant were added to a planetary mixer equipped with a disperser. The overall solid content concentration was adjusted to 52% with deionized water, and the resultant was agitated to obtain a mixed liquid.

To the mixed liquid, 1 part in terms of solid content of a 40% aqueous dispersion including a styrene-butadiene copolymer (glass transition temperature: −15° C.) was added. The overall solid content concentration was adjusted to 50% by adding deionized water to the mixture. The mixture was defoamed under reduced pressure to yield a negative electrode slurry composition.

### (e) Production of Negative Electrode

The negative electrode slurry composition obtained as above was applied to a 20 μm thick copper foil using a comma coater and dried so that the thickness after drying was approximately 150 μm. The drying was performed by transporting the copper foil at a speed of 0.5 m/min through an oven at 60° C. for 2 minutes. Subsequently, the copper foil was heated for 2 minutes at 120° C. to yield a negative electrode sheet. The negative electrode sheet was then rolled in a roll press to obtain a negative electrode having a negative electrode active material layer.

### (f) Preparation of Separator

A single-layer polypropylene separator (width 65 mm, length 500 mm, thickness 25 μm, produced by a dry method, porosity 55%) was cut out as a 5 cm×5 cm square.

### (g) Production of Lithium Ion Secondary Battery

An aluminum packing case was prepared as the casing of the battery. The positive electrode obtained as above was cut into a 4 cm×4 cm square and disposed so that the front face, i.e. the collector side, was in contact with the aluminum packing case. The square separator obtained as above was disposed on the surface of the positive electrode active material layer. Next, the negative electrode obtained as above was cut into a 4.2 cm×4.2 cm square and disposed on the separator so that the front face, i.e. the negative electrode active material layer side, faced the separator. The aluminum packing was then filled with a 1.0 M concentration LiPF₆ solution containing 2.0% of vinylene carbonate. The solvent for the LiPF₆ solution was a mixed solvent of ethylene carbonate (EC) and ethyl methyl carbonate (EMC) (EC/EMC=3/7 (volume ratio)). Furthermore, in order to tightly seal the opening of the aluminum packing, the aluminum case was closed by heat sealing at 150° C. to produce a laminated lithium ion secondary battery (laminated cell).

The rate characteristics and low temperature output characteristics of this laminated cell were assessed.

### Example 2

Composite particles (volume average particle size: 63 μm; coverage factor of coated positive electrode active material: 80%) were produced similarly to those of Example 1, differing in that a lithium oxide of Co—Ni—Mn was used instead of a Li₂MnO₃—LiNiO₂ based solid solution positive electrode active material. A laminated lithium ion secondary battery was then produced.

### Example 3

Composite particles (volume average particle size: 63 μm; coverage factor of coated positive electrode active material: 82%) were produced similarly to those of Example 1, differing in that Ketjen black (“EC600JD” manufactured by Lion corporation) was used instead of acetylene black as the conductive material in the coating material added upon production of the coated positive electrode active material. A laminated lithium ion secondary battery was then produced.

### Example 4

Composite particles (volume average particle size: 67 μm; coverage factor of coated positive electrode active material: 84%) were produced similarly to those of Example 1, differing in that an aqueous solution including the water soluble resin 2 containing an acidic functional group was used instead of the aqueous solution including the water soluble resin 1 containing an acidic functional group. A laminated lithium ion secondary battery was then produced.

### Example 5

Composite particles (volume average particle size: 70 μm; coverage factor of coated positive electrode active material: 84%) were produced similarly to those of Example 1, differing in that an aqueous solution including the water soluble resin 3 containing an acidic functional group was used instead of the aqueous solution including the water soluble resin 1 containing an acidic functional group. A laminated lithium ion secondary battery was then produced.

### Example 6

Composite particles (volume average particle size: 66 μm; coverage factor of coated positive electrode active material: 84%) were produced similarly to those of Example 1, differing in that the amount of the aqueous solution including the water soluble resin 1 containing an acidic functional group was 4 parts in terms of solid content, and in that the 1% aqueous solution of carboxymethyl cellulose was not added. A laminated lithium ion secondary battery was then produced.

### Example 7

Composite particles (volume average particle size: 65 μm; coverage factor of coated positive electrode active material: 84%) were produced similarly to those of Example 1, differing in that the amount of the aqueous solution including the water soluble resin 1 containing an acidic functional group was 2.5 parts in terms of solid content, and in that the amount of the 1% aqueous solution of carboxymethyl cellulose was 0.5 parts in terms of solid content. A laminated lithium ion secondary battery was then produced.

### Example 8

Composite particles (volume average particle size: 70 μm; coverage factor of coated positive electrode active material: 84%) were produced similarly to those of Example 1, differing in that the amount of the aqueous solution including the water soluble resin 1 containing an acidic functional group was 1 part in terms of solid content, and in that the amount of the 1% aqueous solution of carboxymethyl cellulose was 2 parts in terms of solid content. A laminated lithium ion secondary battery was then produced.

### Example 9

Composite particles (volume average particle size: 65 μm; coverage factor of coated positive electrode active material: 84%) were produced similarly to those of Example 1, differing in that a 40% aqueous dispersion of the granular binder resin 2 was used instead of a 40% aqueous dispersion of the granular binder resin 1. A laminated lithium ion secondary battery was then produced.

### Example 10

Composite particles (volume average particle size: 62 μm; coverage factor of coated positive electrode active material: 0%) were produced similarly to those of Example 1, differing in that the Li₂MnO₃—LiNiO₂ based solid solution positive electrode active material was not coated with coating material, and in that the amount of the acetylene black added to the slurry composition for composite particles was 5 parts. A laminated lithium ion secondary battery was then produced.

### Example 11

Composite particles (volume average particle size: 63 μm; coverage factor of coated positive electrode active material: 84%) were produced similarly to those of Example 1, differing in that an aqueous dispersion of the coating resin 2 was used instead of an aqueous dispersion of the coating resin 1. A laminated lithium ion secondary battery was then produced.

### Example 12

Composite particles (volume average particle size: 62 μm; coverage factor of coated positive electrode active material: 85%) were produced similarly to those of Example 1, differing in that an aqueous dispersion of the coating resin 3 was used instead of an aqueous dispersion of the coating resin 1. A laminated lithium ion secondary battery was then produced.

### Example 13

Composite particles (volume average particle size: 67 μm; coverage factor of coated positive electrode active material: 82%) were produced similarly to those of Example 1, differing in that the content of the acetylene black was 2.5 parts (of which 1 part was blended into the coating material). A laminated lithium ion secondary battery was then produced.

### Comparative Example 1

Composite particles (volume average particle size: 63 μm; coverage factor of coated positive electrode active material: 84%) were produced similarly to those of Example 1, differing in that no conductive material was added to the composite particles. A laminated lithium ion secondary battery was then produced.

### Comparative Example 2

Composite particles (volume average particle size: 71 μm; coverage factor of coated positive electrode active material: 84%) were produced similarly to those of Example 1, differing in that the aqueous solution including the water soluble resin 1 containing an acidic functional group was not used, and in that the amount of the 1% aqueous solution of carboxymethyl cellulose was 3 parts in terms of solid content. A laminated lithium ion secondary battery was then produced.

### Comparative Example 3

Composite particles (volume average particle size: 65 μM; coverage factor of coated positive electrode active material: 84%) were produced similarly to those of Example 1, differing in that the amount of the aqueous solution including the water soluble resin 1 containing an acidic functional group was 12 parts in terms of solid content, and in that the 1% aqueous solution of carboxymethyl cellulose was not added. A laminated lithium ion secondary battery was then produced.

### Comparative Example 4

The slurry composition for composite particles obtained in Example 1 was not transformed into composite particles, but rather was applied to a 20 μm thick aluminum foil (collector) using a comma coater and dried so that the thickness after drying was approximately 200 μm. The drying was performed by transporting the aluminum foil at a speed of 0.5 m/min through an oven at 60° C. for 2 minutes. Subsequently, the aluminum foil was heated for 2 minutes at 120° C. to yield a positive electrode sheet. The positive electrode sheet was then rolled in a roll press to obtain a positive electrode having a positive electrode active material layer (in Table 1, this positive electrode production method is listed as “β”). Subsequent steps were performed in the same way as Example 1 to produce a laminated lithium ion secondary battery.

### Comparative Example 5

Composite particles (volume average particle size: 64 μm; coverage factor of coated positive electrode active material: 0%) were produced similarly to those of Example 1, differing in that the Li₂MnO₃—LiNiO₂ based solid solution positive electrode active material was not coated with coating material, the amount of the acetylene black added to the slurry composition for composite particles was 5 parts, the aqueous solution including the water soluble resin 1 containing an acidic functional group was not used, and the amount of the 1% aqueous solution of carboxymethyl cellulose was 3 parts in terms of solid content. A laminated lithium ion secondary battery was then produced.

TABLE 1

| | | | Examples | | | | | | | | |
|---|---|---|---|---|---|---|---|---|---|---|---|
| | | | 1 | 2 | 3 | 4 | 5 | 6 | 7 | 8 | 9 |
| Formulation | Ni containing | Li₂MnO₃—LiNiO₂ based | 100 | 0 | 100 | 100 | 100 | 100 | 100 | 100 | 100 |
| and other | positive electrode | solid solution | | | | | | | | | |
| properties of | active material | lithium oxide of Co—Ni—Mn | 0 | 100 | 0 | 0 | 0 | 0 | 0 | 0 | 0 |
| composite | (parts by mass) | | | | | | | | | | |

| particles | Coated (Y or N) | | Y | Y | Y | Y | Y | Y | Y | Y | Y |
|---|---|---|---|---|---|---|---|---|---|---|---|
| | Coverage factor (%) | | 84 | 80 | 82 | 84 | 84 | 84 | 84 | 84 | 84 |
| | SP value of coating resin (cal/cm³)^{1/2} | | 11.45 | 11.45 | 11.45 | 11.45 | 11.45 | 11.45 | 11.45 | 11.45 | 11.45 |
| | Water soluble resin including | resin 1 | 2 | 2 | 2 | 0 | 0 | 4 | 2.5 | 1 | 2 |
| | a monomeric unit containing | resin 2 | 0 | 0 | 0 | 2 | 0 | 0 | 0 | 0 | 0 |
| | an acidic functional group | resin 3 | 0 | 0 | 0 | 0 | 2 | 0 | 0 | 0 | 0 |
| | (parts by mass) | | | | | | | | | | |
| | Conductive material | acetylene black* | 3(2) | 3(2) | 3(0) | 3(2) | 3(2) | 3(2) | 3(2) | 3(2) | 3(2) |
| | (parts by mass) | Ketjen black* | 0(0) | 0(0) | 0(2) | 0(0) | 0(0) | 0(0) | 0(0) | 0(0) | 0(0) |
| | | total | 5 | 5 | 5 | 5 | 5 | 5 | 5 | 5 | 5 |
| | Granular binder | resin 1 | 2 | 2 | 2 | 2 | 2 | 2 | 2 | 2 | 0 |
| | (parts by mass) | resin 2 | 0 | 0 | 0 | 0 | 0 | 0 | 0 | 0 | 2 |

| | | | | | | | | | |
|---|---|---|---|---|---|---|---|---|---|
| Carboxymethyl cellulose (parts by mass) | 1 | 1 | 1 | 1 | 1 | 0 | 0.5 | 2 | 1 |
| Size of composite particles (μm) | 65 | 63 | 63 | 67 | 70 | 66 | 65 | 70 | 65 |

| Positive electrode production method | | α | α | α | α | α | α | α | α | α |
|---|---|---|---|---|---|---|---|---|---|---|
| Assessment results | Corrosiveness of the collector | A | A | A | A | A | A | A | A | A |
| | Rate characteristics | A | B | A | A | A | B | B | A | B |
| | Low temperature output characteristics | A | A | B | A | A | A | A | B | A |

| | | | Examples | | | | Comparative Examples | | | | |
|---|---|---|---|---|---|---|---|---|---|---|---|
| | | | 10 | 11 | 12 | 13 | 1 | 2 | 3 | 4 | 5 |
| Formulation | Ni containing | Li₂MnO₃—LiNiO₂ based | 100 | 100 | 100 | 100 | 100 | 100 | 100 | 100 | 100 |
| and other | positive electrode | solid solution | | | | | | | | | |
| properties of | active material | lithium oxide of Co—Ni—Mn | 0 | 0 | 0 | 0 | 0 | 0 | 0 | 0 | 0 |
| composite | (parts by mass) | | | | | | | | | | |

| particles | Coated (Y or N) | | N | Y | Y | Y | Y | Y | Y | Y | N |
|---|---|---|---|---|---|---|---|---|---|---|---|
| | Coverage factor (%) | | 0 | 84 | 85 | 82 | 84 | 84 | 84 | 84 | 0 |
| | SP value of coating resin (cal/cm³)^{1/2} | | — | 10.57 | 11.91 | 11.45 | 11.45 | 11.45 | 11.45 | 11.45 | — |
| | Water soluble resin including | resin 1 | 2 | 2 | 2 | 2 | 2 | 0 | 12 | 2 | 0 |
| | a monomeric unit containing | resin 2 | 0 | 0 | 0 | 0 | 0 | 0 | 0 | 0 | 0 |
| | an acidic functional group | resin 3 | 0 | 0 | 0 | 0 | 0 | 0 | 0 | 0 | 0 |
| | (parts by mass) | | | | | | | | | | |
| | Conductive material | acetylene black* | 5(0) | 3(2) | 3(2) | 1.5(1) | 0(0) | 3(2) | 3(2) | 3(2) | 5(0) |
| | (parts by mass) | Ketjen black* | 0(0) | 0(0) | 0(0) | 0(0) | 0(0) | 0(0) | 0(0) | 0(0) | 0(0) |
| | | total | 5 | 5 | 5 | 2.5 | 0 | 5 | 5 | 5 | 5 |
| | Granular binder | resin 1 | 2 | 2 | 2 | 2 | 2 | 2 | 2 | 2 | 2 |
| | (parts by mass) | resin 2 | 0 | 0 | 0 | 0 | 0 | 0 | 0 | 0 | 0 |

| Carboxymethyl cellulose (parts by mass) | | 1 | 1 | 1 | 1 | 1 | 3 | 0 | 1 | 3 |
|---|---|---|---|---|---|---|---|---|---|---|
| Size of composite particles (μm) | | 62 | 63 | 62 | 67 | 63 | 71 | 65 | — | 64 |
| Positive electrode production method | | α | α | α | α | α | α | α | β | α |
| Assessment results | Corrosiveness of the collector | B | A | A | A | A | C | A | E | D |
| | Rate characteristics | B | A | A | B | D | C | C | D | D |
| | Low temperature output characteristics | A | A | A | B | D | D | C | D | D |

For the acetylene black and Ketjen black in Table 1, the number inside the parentheses indicates the amount blended within the coating material, and the number outside the parentheses indicates the amount blended at the time of preparing the slurry composition for composite particles.

As Table 1 clearly shows, corrosion of the collector is suppressed and the rate characteristics and low temperature output characteristics are excellent in Examples 1 to 13, in which composite particles containing a water soluble resin including a monomeric unit containing an acidic functional group at a predetermined ratio were used, as compared to Comparative Example 2, in which composite particles not containing a water soluble resin including a monomeric unit containing an acidic functional group were used. Furthermore, Examples 1 to 13 have excellent rate characteristics and low temperature output characteristics as compared to Comparative Example 3, in which the composite particles that were used included, per 100 parts by mass of the Ni containing positive electrode active material, 12 parts by mass of a water soluble resin including a monomeric unit containing an acidic functional group.

While corrosion of the collector was suppressed in Comparative Example 1, the conductivity of the positive electrode was vastly inferior due to the lack of conductive material, and hence the rate characteristics and low temperature output characteristics of Comparative Example 1 were greatly inferior to those of Examples 1 to 13.

Furthermore, in Comparative Example 4, the slurry composition was not transformed into composite particles, but rather applied onto the collector and dried to form a positive electrode active material layer. Therefore, corrosion of the collector was pronounced, and the rate characteristics and output characteristics of Comparative Example 4 were greatly inferior to those of Examples 1 to 13.

In Comparative Example 5, a water soluble resin including a monomeric unit containing an acidic functional group was not used, and furthermore the Ni containing positive electrode active material was not coated with coating material. Therefore, corrosion of the collector was pronounced, and the rate characteristics and output characteristics of Comparative Example 5 were greatly inferior to those of Examples 1 to 13.

1. Composite particles for a positive electrode of an electrochemical element, comprising:
a conductive material, a Ni containing positive electrode active material, a water soluble resin including a monomeric unit containing an acidic functional group, and a granular binder resin, wherein
a content of the water soluble resin including a monomeric unit containing an acidic functional group is 1 to 10 parts by mass per 100 parts by mass of the Ni containing positive electrode active material.

2. The composite particles for a positive electrode of an electrochemical element according to claim 1, wherein the Ni containing positive electrode active material is coated with a coating material including a conductive material and a coating resin.

3. The composite particles for a positive electrode of an electrochemical element according to claim 2, wherein an SP value of the coating resin is from 9.5 to 13 (cal/cm³)^{1/2}.

4. The composite particles for a positive electrode of an electrochemical element according to claim 1, wherein the Ni containing positive electrode active material is a Li₂MnO₃—LiNiO₂ based solid solution positive electrode active material.

5. The composite particles for a positive electrode of an electrochemical element according to claim 1, wherein the water soluble resin including a monomeric unit containing an acidic functional group includes at least one selected from the group consisting of a monomeric unit containing a sulfonic acid group, a monomeric unit containing a carboxyl group, and a monomeric unit containing a phosphoric acid group.

6. The composite particles for a positive electrode of an electrochemical element according to claim 1, wherein the granular binder resin includes a monomeric unit of (meth)acrylic acid ester with a carbon number of 6 to 15, an α,β-unsaturated nitrile monomeric unit, and a monomeric unit containing a carboxylic acid group.

7. The composite particles for a positive electrode of an electrochemical element according to claim 1, wherein the granular binder resin includes a monomeric unit of dibasic acid.

8. An electrochemical element comprising a positive electrode including a collector and a positive electrode active material layer obtained by formation with the composite particles for a positive electrode of an electrochemical element according to claim 1.

9. A method for producing composite particles for a positive electrode of an electrochemical element, comprising:
drying and granulating an aqueous slurry composition including a conductive material, a Ni containing positive electrode active material, a water soluble resin including a monomeric unit containing an acidic functional group, and a granular binder resin to obtain composite particles, wherein
a content in the slurry composition of the water soluble resin including a monomeric unit containing an acidic functional group is 1 to 10 parts by mass per 100 parts by mass of the Ni containing positive electrode active material.

10. The method for producing composite particles for a positive electrode of an electrochemical element according to claim 9, wherein the water soluble resin including a monomeric unit containing an acidic functional group is formed as an ammonium salt by at least one selected from the group consisting of ammonia and an amine compound with a molecular weight of at most 1000.

11. The method for producing composite particles for a positive electrode of an electrochemical element according to claim 9, wherein the Ni containing positive electrode active material is coated with a coating material including a conductive material and a coating resin.

12. The method for producing composite particles for a positive electrode of an electrochemical element according to claim 11, wherein an SP value of the coating resin is from 9.5 to 13 (cal/cm³)^{1/2}.

13. The method for producing composite particles for a positive electrode of an electrochemical element according to claim 9, wherein the Ni containing positive electrode active material is a Li₂MnO₃—LiNiO₂ based solid solution positive electrode active material.
